(19) United States
(12) Patent Application Publication
(10) Pub. No.: US 2024/0325912 A1
(43) Pub. Date: Oct. 3, 2024

(54) METHOD AND APPARATUS FOR CONTROLLING VIRTUAL OBJECT, DEVICE, AND MEDIUM

(71) Applicant: Tencent Technology (Shenzhen) Company Limited, Shenzhen (CN)

(72) Inventor: Weijian CUI, Shenzhen (CN)

(73) Assignee: Tencent Technology (Shenzhen) Company Limited, Shenzhen (CN)

(21) Appl. No.: 18/740,443

(22) Filed: Jun. 11, 2024

Related U.S. Application Data
(63) Continuation of application No. PCT/CN2023/102595, filed on Jun. 27, 2023.

(30) Foreign Application Priority Data
Aug. 18, 2022 (CN) 202210995373.1

(51) Int. Cl. A63F 13/56; A63F 13/537

(52) U.S. Cl. CPC A63F 13/56; A63F 13/537

(57) ABSTRACT

In a method for controlling a virtual object, a picking control that includes at least two interaction regions is displayed. One of the interaction regions corresponds to a usage manner of a virtual prop. In response to an operation performed on a reference interaction region of the at least two interaction regions, the virtual object is controlled to interact with a reference virtual prop in the reference interaction region of the at least two interaction regions. Apparatus and non-transitory computer-readable storage medium counterpart embodiments are also contemplated.

### RELATED APPLICATIONS

The present application is a continuation of International Application No. PCT/CN2023/102595, filed on Jun. 27, 2023, which claims priority to Chinese Patent Application No. 202210995373.1, filed on Aug. 18, 2022. The entire disclosures of the prior applications are hereby incorporated by reference.

### FIELD OF THE TECHNOLOGY

This disclosure relates to the technical field of virtual scenes, including a method and an apparatus for controlling a virtual object, a device, and a medium.

### BACKGROUND OF THE DISCLOSURE

In a network game having a virtual environment, a player may control a virtual object to pick up and replace a virtual prop.

In an example, after the virtual object enters a picking region, the player may click/tap a virtual prop displayed in the picking region, and put the virtual prop into a virtual backpack. When the player needs to replace a virtual prop with the picked virtual prop, the player may open the virtual backpack, and replace a virtual prop currently being used with the picked virtual prop.

### SUMMARY

This disclosure provides a method and an apparatus for controlling a virtual object, a device, and a non-transitory computer-readable storage medium, which allow use of a to-be-used virtual prop in a corresponding usage manner, thereby reducing virtual prop picking and replacing operations, and improving virtual prop usage efficiency. Moreover, since virtual prop picking and replacement are controlled by a player in a network game, through reduction of the virtual prop picking and replacing operations, control operations of the player can be reduced. In this case, services provided by a server of the network game based on the control operations performed by the player are reduced, thereby reducing resource consumption required by the server, and reducing operating pressure of the server. Examples of technical solutions are provided in the following descriptions.

According to an aspect of this disclosure, a method for controlling a virtual object is provided. In the method, a picking control that includes at least two interaction regions is displayed. One of the interaction regions corresponds to a usage manner of a virtual prop. In response to an operation performed on a reference interaction region of the at least two interaction regions, the virtual object is controlled to interact with a reference virtual prop in the reference interaction region of the at least two interaction regions.

According to an aspect of this disclosure, an apparatus for controlling a virtual object is provided. The apparatus includes processing circuitry configured to display a picking control that includes at least two interaction regions. One of the interaction regions corresponds to a usage manner of a virtual prop. The processing circuitry configured to control the virtual object to interact with a reference virtual prop in the reference interaction region of the at least two interaction regions in response to an operation performed on a reference interaction region of the at least two interaction regions.

According to an aspect of this disclosure, a computer device is provided. The computer device includes a memory and a processor, the memory having at least one piece of program code stored therein, the program code being loaded and executed by the processor, to cause the computer device to implement the above method for controlling a virtual object.

According to an aspect of this disclosure, a non-transitory computer-readable storage medium is provided, the non-transitory computer-readable storage medium having a computer program stored therein, the computer program being configured to be executed by a processor, to cause a computer device to implement the above method for controlling a virtual object.

According to an aspect of this disclosure, a chip is provided, the chip including a programmable logic circuit and/or program instructions, an electronic device having the chip installed therein, when running, being configured to implement the above method for controlling a virtual object.

According to an aspect of this disclosure, a computer program product is provided, including computer instructions, the computer instructions being stored in a non-volatile computer-readable storage medium, a processor reading the computer instructions from the non-volatile computer-readable storage medium and executing the computer instructions, to cause a computer device to implement the above method for controlling a virtual object.

Since the displayed picking control includes the at least two interaction regions, the virtual object may be controlled to use the virtual prop in the usage manners corresponding to the at least two interaction regions, thereby reducing operations of a plurality of usage manners such as virtual prop picking and replacement, and improving virtual prop usage efficiency. Correspondingly, control operations (for controlling virtual prop picking or replacement) performed by a player in a network game are reduced. In this case, services provided by a server of the network game based on the control operations performed by the player are reduced, thereby reducing resource consumption required by the server, and reducing operating pressure of the server.

### BRIEF DESCRIPTION OF THE DRAWINGS

FIG. 1 is a schematic structural diagram of a terminal according to an aspect of this disclosure.

FIG. 2 is a structural block diagram of a computer system according to an aspect of this disclosure.

FIG. 3 is a schematic interface diagram of a method for using a virtual prop according to an aspect of this disclosure.

FIG. 4 is a flowchart of a method for using a virtual prop according to an aspect of this disclosure.

FIG. 5 is a schematic diagram of a picking control according to an aspect of this disclosure.

FIG. 6 is a schematic interface diagram of a method for using a virtual prop according to an aspect of this disclosure.

FIG. 7 is a schematic interface diagram of a method for using a virtual prop according to an aspect of this disclosure.

FIG. 8 is a flowchart of a method for using a virtual prop according to an aspect of this disclosure.

FIG. 9 is a flowchart of a method for using a virtual prop according to an aspect of this disclosure.

FIG. 10 is a flowchart of a method for using a virtual prop according to an aspect of this disclosure.

FIG. 11 is a flowchart of a method for using a virtual prop according to an aspect of this disclosure.

FIG. 12 is a flowchart of a method for using a virtual prop according to an aspect of this disclosure.

FIG. 13 is a schematic diagram of an apparatus for using a virtual prop according to an aspect of this disclosure.

FIG. 14 is a structural block diagram of a computer device according to an aspect of this disclosure.

### DETAILED DESCRIPTION

To make objectives, technical solutions, and advantages and implementations of this disclosure are further described in detail below with reference to drawings.

First, examples of terms involved in aspects of this disclosure are described. The descriptions of the terms are provided as examples only and are not intended to limit the scope of the disclosure.

Virtual environment: It is, for example, a virtual environment displayed (or provided) when an application runs in a terminal. The virtual environment may be a simulated world of the real world, a semi-simulated and semi-fabricated world, or a completely fabricated environment. The virtual environment may be any one of a two-dimensional virtual environment, a 2.5-dimensional virtual environment, and a three-dimensional virtual environment, which is not limited in this disclosure.

Virtual object: It is, for example, a movable object in a virtual environment. The movable object may be a virtual character, a virtual animal, a cartoon character, or the like, for example, a person, an animal, a plant, an oil barrel, a wall, or a stone displayed in a three-dimensional virtual environment. In an aspect, the virtual object is a three-dimensional model created based on a skeletal animation technology. Each virtual object has a shape and a volume in the three-dimensional virtual environment, and occupies a partial space in the three-dimensional virtual environment.

A method provided in this disclosure is applicable to an application having a virtual environment and a virtual object. For example, an application supporting a virtual environment is an application in which a user may control a virtual object to move in the virtual environment. For example, the method provided in this disclosure is applicable to any one of a virtual reality (VR) application, an augmented reality (AR) program, a three-dimensional map program, a VR game, an AR game, a shooting game (including but not limited to a first-person shooting game (FPS) and a third-person shooting game (TPS)), a battle arena game (including but not limited to a battle royale (BR) game and a multiplayer online battle arena (MOBA)), a simulation game (SLG), a racing game, a role-playing game, an adventure game, and a sandbox game.

For example, a game in the virtual environment is composed of maps of one or more game worlds. A virtual environment in the game simulates real-world scenes, and a user may control a virtual object in the game to perform actions such as walking, running, jumping, shooting, fighting, driving, attacking another virtual object with a virtual weapon, and perform charge attack on another virtual object with a virtual weapon in the virtual environment, which realizes high interaction, and enables a plurality of users to team up online for a battle arena.

In an aspect, the above application may be a client. The client supports at least one of a Windows operating system, an Apple Macintosh operating system, an Android operating system, an IOS operating system, and a LINUX operating system, and clients of different operating systems may be connected and communicate with each other. In an aspect, the client is a program applicable to a mobile terminal with a touchscreen. In an aspect, the client is an application developed based on a three-dimensional engine. For example, the three-dimensional engine is a Unity engine.

The terminal in this application may be a desktop computer, a laptop portable computer, a mobile phone, a tablet computer, an e-book reader, a player, or the like. The terminal has a client supporting the virtual environment installed and running therein, for example, a client supporting a three-dimensional virtual environment. The client may be an application. In an aspect, the application may be a stand-alone application, for example, a stand-alone 3D game program, or may be an online application.

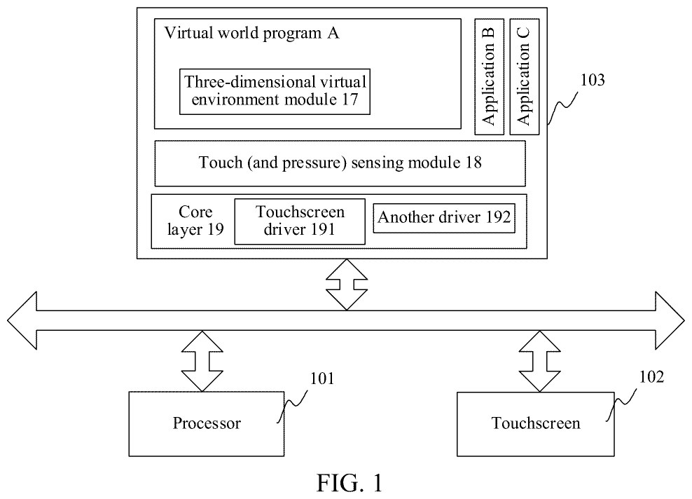

FIG. 1 is a schematic structural diagram of a terminal according to an aspect of this disclosure. The terminal includes a processor 101, a touchscreen 102, and a memory 103.

The processor 101 may be at least one of a single-core processor, a multi-core processor, an embedded chip, and a processor having a capability of running instructions.

The touchscreen 102 includes a normal touchscreen or a pressure sensing touchscreen. The normal touchscreen can measure a pressing operation or a sliding operation applied to the touchscreen 102. The pressure sensing touchscreen can measure a pressing force applied to the touchscreen 102.

The memory 103 has a program executable by the processor 101 stored therein. For example, the memory 103 has a virtual environment program A (i.e., a virtual world program A shown in FIG. 1), an application B, an application C, a touch (and pressure) sensing module 18, and a core layer 19 of an operating system stored therein. The virtual environment program A is an application developed based on a three-dimensional virtual environment module 17. In an aspect, the virtual environment program A includes but is not limited to at least one of a game program, a VR program, a three-dimensional map program, and a three-dimensional demonstration program developed based on the three-dimensional virtual environment module (which is also referred to as a virtual environment module) 17. For example, when an operating system of the terminal adopts an Android operating system, the virtual environment program A is developed by using a Java programming language and a C#language. For another example, when the operating system of the terminal adopts an IOS operating system, the virtual environment program A is developed by using an Object-C programming language and the C#language.

The three-dimensional virtual environment module 17 is a module supporting a plurality of operating system platforms. For example, the three-dimensional virtual environment module may be configured for program development in a plurality of fields such as a game development field, a VR field, and a three-dimensional mapping field. A specific type of the three-dimensional virtual environment module 17 is not limited in this aspect of this disclosure. In the following aspects, a description is provided by using an example in which the three-dimensional virtual environment module 17 is a module developed by using a Unity engine.

The touch (and pressure) sensing module 18 is a module configured to receive a touch event (and a pressure touch event) reported by a touchscreen driver 191. In an aspect, the touch sensing module may not have a pressure sensing function and not receive a pressure touch event. The touch event includes a type and coordinate values of the touch event. The type of the touch event includes but is not limited to a touch start event, a touch move event, and a touch end event. The pressure touch event includes a pressure value and coordinate values of the pressure touch event. The coordinate values are configured for indicating a touch position of the pressure touch operation on a display. In an aspect, an axis of abscissas is established in a horizontal direction of the display, and an axis of vertical coordinates (i.e., an axis of ordinates) is established in a vertical direction of the display, to obtain a two-dimensional coordinate system.

For example, the core layer 19 includes the touchscreen driver 191 and another driver 192. The touchscreen driver 191 is a module configured to detect a pressure touch event. After detecting the pressure touch event, the touchscreen driver 191 transmits the pressure touch event to the touch (and pressure) sensing module 18.

The another driver 192 may be a driver related to the processor 101, a driver related to the memory 103, a driver related to a network component, a driver related to a sound component, or the like.

A person skilled in the art may learn that the above is merely a general example of the structure of the terminal. In different aspects, the terminal may have more or fewer components. For example, the terminal may further include a gravity acceleration sensor, a gyroscope sensor, a power supply, and the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

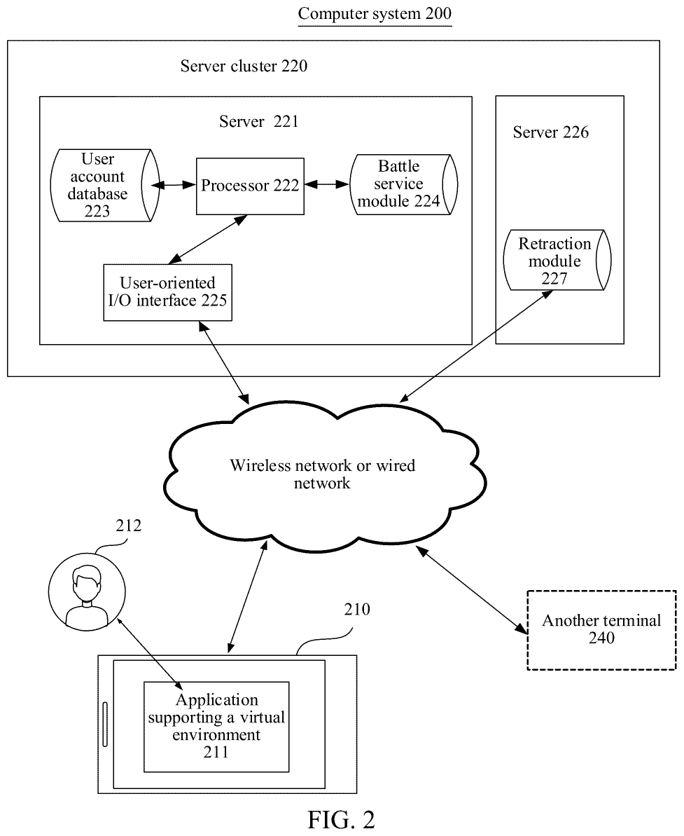

FIG. 2 is a structural block diagram of a computer system according to an aspect of this disclosure. A computer system 200 includes a terminal 210 and a server cluster 220.

The terminal 210 has a client 211 (i.e., an application 211 supporting a virtual environment shown in FIG. 2) supporting a virtual environment installed and running therein. The client 211 may be an application supporting the virtual environment. When the client 211 runs in the terminal, a user interface (UI) of the client 211 is displayed on a screen of the terminal 210. In this aspect, a description is provided by using an example in which the client is an FPS. The terminal 210 is a terminal used by a first user 212. The first user 212 controls a first virtual object in the virtual environment to perform activities by using the terminal 210. The first virtual object may be referred to as a first virtual object of the first user 212. The activities of the first virtual object include but are not limited to at least one of adjusting a body posture, crawling, walking, running, riding, flying, jumping, driving, picking, shooting, attacking, and throwing. For example, the first virtual object is a first virtual character such as a simulated person or a cartoon person.

A device type of the terminal 210 includes at least one of a smart phone, a tablet computer, an e-book reader, an MP3 player, an MP4 player, a laptop portable computer, and a desktop computer.

FIG. 2 shows only one terminal. However, in a different aspect, a plurality of other terminals 240 exist. In an aspect, at least one another terminal 240 is a terminal corresponding to a developer. The another terminal 240 has a development and editing platform of the client in the virtual environment installed therein. The developer may edit and update the client on the another terminal 240, and transmit an installation package of the updated client to the server cluster 220 through a wired or wireless network. The terminal 210 may download the installation package of the client from the server cluster 220 to update the client.

The terminal 210 and the another terminal 240 are connected to the server cluster 220 through the wireless network or a wired network.

The server cluster 220 includes at least one of one server, a plurality of servers, a cloud computing platform, or a virtualization center. The server cluster 220 is configured to provide a backend service for a client supporting a three-dimensional virtual environment. In an aspect, the server cluster 220 is in charge of primary computing, and the terminal is in charge of secondary computing. Alternatively, the server cluster 220 is in charge of the secondary computing, and the terminal is in charge of the primary computing. Alternatively, the server cluster 220 and the terminal perform collaborative computing by using a distributed computing architecture.

In an aspect, the above terminal and server are both computer devices.

In an exemplary example, the server cluster 220 a server 221 and a server 226. The server 221 includes a processor 222, a user account database 223, a battle service module 224, and a user-oriented input/output interface (I/O interface) 225. The server 226 includes a retraction module 227. The processor 222 is configured to load instructions stored in the server 221, and process data in the user account database 223 and the battle service module 224. The user account database 223 is configured to store data of user accounts used by the terminal 210 and the another terminal 240, for example, head portraits of the user accounts, nicknames of the user accounts, combat capability indices of the user accounts, and service regions where the user accounts are located. The battle service module 224 is configured to provide a plurality of battle rooms for battles between users. The user-oriented I/O interface 225 is configured to establish communication with the terminal 210 through the wireless network or the wired network and exchange data.

In a network game having a virtual environment, a player may control a virtual object to pick up and replace a virtual prop. After the virtual object enters a picking region, the player may click/tap a virtual prop displayed in the picking region, and put the virtual prop into a virtual backpack. When the player needs to replace a virtual prop with the picked virtual prop, the player may open the virtual backpack, and replace a virtual prop currently being used with the picked virtual prop. In this process, the player needs to perform a plurality of operations to replace the virtual prop, which leads to relatively low virtual prop usage efficiency. Moreover, a server of the network game needs to provide a plurality of services based on the plurality of operations performed by the player, resulting in relatively large resource consumption required by the server and relatively large running pressure of the server.

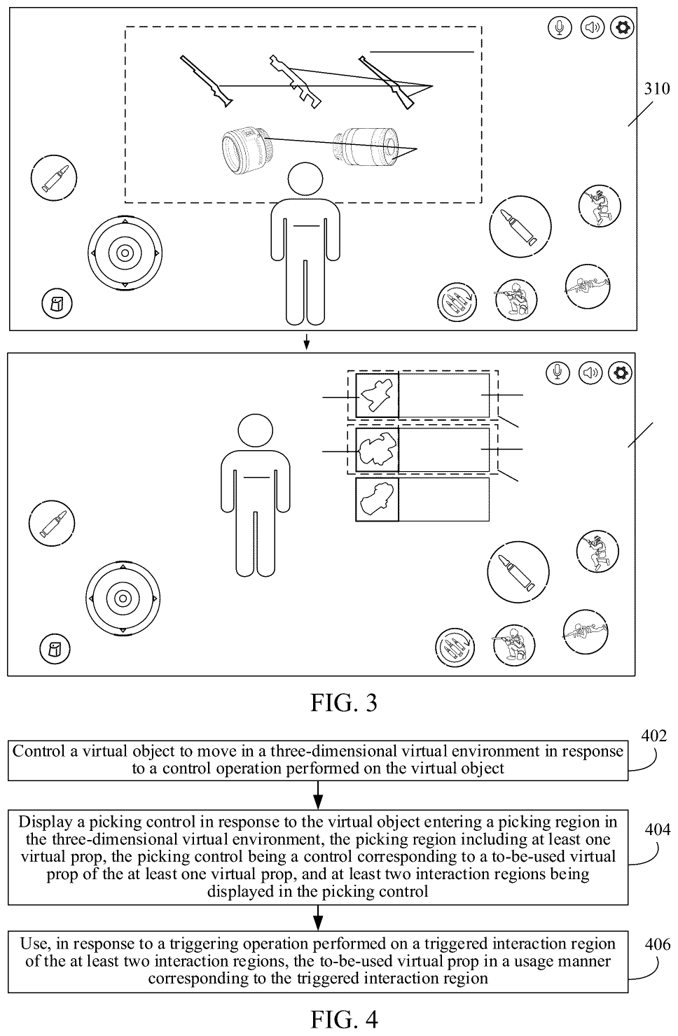

A method for using a virtual prop (which is also referred to as a method for controlling a virtual object) provided in the aspects of this disclosure is described below in combination with the above descriptions of the virtual environment and of the implementation environment. The method may be performed by a computer device. FIG. 3 is a schematic interface diagram of a method for using a virtual prop according to an aspect of this disclosure.

A virtual object 320 is displayed on a display interface 310.

For example, in response to a control operation performed on the virtual object 320, the virtual object 320 is controlled to move in a three-dimensional virtual environment.

A picking region may be further displayed on the display interface 310. The picking region includes at least one virtual prop. A dashed-line box shown in FIG. 3 represents the picking region. The picking region may include virtual props of different types. For example, the picking region includes a virtual prop 01 and a virtual prop 02 of different types. The virtual prop 01 and the virtual prop 02 each have a plurality of styles.

The picking region may be displayed on the display interface 310, or may be hidden on the display interface 310. For example, the picking region is a virtual stall displayed on the display interface 310. A plurality of virtual props are placed on the virtual stall. For another example, the picking region is hidden on the display interface 310. When the virtual object 320 enters the picking region, only the virtual props in the picking region are displayed.

For example, in response to the virtual object 320 entering the picking region in the three-dimensional virtual environment, a picking control is displayed. The picking region includes at least one virtual prop. The picking control is a control corresponding to a to-be-used virtual prop of the at least one virtual prop. At least two interaction regions are displayed in the picking control.

An example in which the to-be-used virtual prop is a virtual prop 1 is used. A first interaction region 331 and a second interaction region 332 are displayed in a picking control 330. Another interaction region may be further displayed in the picking control corresponding to the to-be-used virtual prop. In this disclosure, an example in which two interaction regions are displayed in the picking control corresponding to the to-be-used virtual prop is used. A relevant description of displaying three or more interaction regions is similar to that of displaying the two interaction regions. For the relevant description, reference may be made to the following content. Details are not described.

For example, the picking region includes at least one virtual prop. If the picking region includes a plurality of virtual props, the virtual props may be virtual props of different types. For example, the virtual prop may be one of a virtual fighting prop, a virtual accessory, and a virtual decorative prop.

In an aspect, a display style of the picking control 330 is determined based on a type of the to-be-used virtual prop.

The display style of the picking control 330 may include at least one type of the following display information:
frame colors of the at least two interaction regions;
corner marks of the at least two interaction regions;
brightness of the at least two interaction regions;
shapes of the at least two interaction regions;
transparencies of the at least two interaction regions;
pattern styles in the at least two interaction regions; and
text styles in the at least two interaction regions.

For example, the picking region includes three candidate virtual props, i.e., a virtual prop 1, a virtual prop 2, and a virtual prop 3. A corresponding picking control is displayed for each candidate virtual prop.

If the three candidate virtual props are of three different types, display styles of the three picking controls corresponding to the three candidate virtual props are different. For example, the virtual prop 1 is a virtual fighting prop, the virtual prop 2 is a virtual sight of virtual prop 1, and the virtual prop 3 is a virtual helmet. The three candidate virtual props may be distinguished from each other through display information such as frame colors and corner marks of at least two interaction regions on the picking control of each virtual prop.

For example, in a picking control 330 corresponding to the virtual prop 1, frame colors of a first interaction region 331 and a second interaction region 332 are blue, and a triangle corner mark exists at an upper left corner of the first interaction region 331. In addition, a pattern style of the virtual prop 1 is displayed in the first interaction region 331, and a name of the virtual prop 1 is displayed in the second interaction region 332.

In a picking control 340 corresponding to the virtual prop 2, frame colors of a first interaction region 341 and a second interaction region 342 are orange, and a double sided arrow corner mark exists at an upper left corner of the first interaction region 341. In addition, a pattern style of the virtual prop 2 is displayed in the first interaction region 341, and a name of the virtual prop 2 is displayed in the second interaction region 342.

The picking control corresponding to virtual prop 3 is similar to the above, which is not described in detail.

In an aspect, if the picking region includes a first candidate virtual prop and a second candidate virtual prop, after the virtual object 320 enters the picking region, the first picking control and the second picking control may be displayed. The first picking control is a control corresponding to the first candidate virtual prop, the second picking control is a control corresponding to the second candidate virtual prop, and a display style of the first picking control is different from a display style of the second picking control.

An example in which the first candidate virtual prop is the virtual prop 1, and the second candidate virtual prop is the virtual prop 2 is used. After the player controls the virtual object 320 to enter the picking region, the picking control 330 corresponding to the virtual prop 1 and the picking control 340 corresponding to the virtual prop 2 are displayed on the display interface 310.

Display styles of the picking control 330 and the picking control 340 are different. The two picking controls may be distinguished from each other through a plurality of types of display information such as a frame color, a corner mark, a brightness, a shape, a transparency, a pattern style, and a text style displayed in at least two interaction regions of the two picking controls.

For example, in response to a triggering operation performed on a triggered interaction region of the at least two interaction regions, the to-be-used virtual prop is used in a usage manner corresponding to the triggered interaction region.

Usage manners of the to-be-used virtual prop include at least one of replacement, equipment, dressing, storage, giving, and exchange into virtual currency. For example, if the player triggers the triggered interaction region, the virtual prop used by the virtual object 320 is replaced with the to-be-used virtual prop. For another example, if the player triggers the triggered interaction region, a virtual prop stored in a virtual backpack of the virtual object 320 is updated to a combined virtual prop. The combined virtual prop is composed of the virtual prop stored in the virtual backpack and the to-be-used virtual prop. For example, the combined virtual prop is a virtual hammer composed of a virtual hammerhead and a virtual handheld stick. For another example, if the player triggers the triggered interaction region, the to-be-used virtual prop is exchanged into virtual currency, and a stock of virtual currency of the virtual object 320 is increased.

In an aspect, each of the at least two interaction regions corresponds to at least one usage manner of the to-be-used virtual prop, and different interaction regions correspond to different usage manners.

The example in which the to-be-used virtual prop is the virtual prop 1 is still used. After the player controls the virtual object 320 to enter the picking region, the picking control 330 of the virtual prop 1 is displayed.

Subsequently, if the player triggers the first interaction region 331, i.e., the triggered interaction region is the first interaction region 331, the virtual prop 1 is used in a first usage manner corresponding to the first interaction region 331. If the player triggers the second interaction region 332, i.e., the triggered interaction region is the second interaction region 332, the virtual prop 1 is used in a second usage manner corresponding to the second interaction region 332.

The first usage manner is different from the second usage manner.

Based on the above content, the usage manners of the to-be-used virtual prop include at least one of replacement, equipment, dressing, storage, giving, and exchange into virtual currency. In an aspect, the usage manner corresponding to each of the at least two interaction regions includes at least one of the following manners:
replacing a first virtual prop used by the virtual object with the to-be-used virtual prop, the first virtual prop being a virtual prop of the same type as the to-be-used virtual prop;
replacing a second virtual prop reserved by the virtual object with the to-be-used virtual prop, the second virtual prop being a virtual prop of the same type as the to-be-used virtual prop;
replacing a third virtual prop used by the virtual object with the to-be-used virtual prop, the third virtual prop being a virtual prop that is of the same type as, but of a different style from, the to-be-used virtual prop;
replacing a fourth virtual prop reserved by the virtual object with the to-be-used virtual prop, the fourth virtual prop being a virtual prop that is of the same type as, but of a different style from, the to-be-used virtual prop;
upgrading a fifth virtual prop owned by the virtual object to the to-be-used virtual prop, the fifth virtual prop being a virtual prop of the same type as the to-be-used virtual prop;
updating a sixth virtual prop owned by the virtual object to a combined virtual prop, the combined virtual prop being generated through combination of the sixth virtual prop and the to-be-used virtual prop;
putting the to-be-used virtual prop into the virtual backpack, i.e., storing the to-be-used virtual prop through the virtual backpack;
giving the to-be-used virtual prop to another virtual object;
equipping the virtual object with the to-be-used virtual prop or dressing the virtual object in the to-be-used virtual prop; and
exchanging the to-be-used virtual prop into virtual currency.

The usage manners corresponding to the at least two interaction regions may be set based on an actual need.

The example in which the to-be-used virtual prop is the virtual prop 1 is still used. In the picking control 330 corresponding to the virtual prop 1, the usage manner corresponding to the first interaction region 331 may be replacing the second virtual prop reserved by the virtual object with the to-be-used virtual prop, and the usage manner corresponding to the second interaction region 332 may be replacing the first virtual prop used by the virtual object with the to-be-used virtual prop.

Similarly, the example in which the to-be-used virtual prop is the virtual prop 2 is used. In the picking control 340 corresponding to the virtual prop 2, the usage manner corresponding to the first interaction region 341 may be replacing the first virtual prop used by the virtual object with the to-be-used virtual prop, and the usage manner corresponding to the second interaction region 342 may be putting the to-be-used virtual prop into the virtual backpack.

An aspect of this disclosure provides a method for controlling a virtual object. The method includes the following operation 1 and operation 2.

Operation 1: Display a picking control, the picking control including at least two interaction regions, each interaction region corresponding to a usage manner of a virtual prop.

Each interaction region may correspond to at least one usage manner of the virtual prop. A quantity of usage manners corresponding to each interaction region is not limited in this disclosure. Different interaction regions may correspond to the same usage manner, or may correspond to different usage manners.

Operation 2: Control the virtual object to use the virtual prop in the usage manners corresponding to the at least two interaction regions.

Since the interaction region corresponds to the usage manner of the virtual prop, the virtual object may be controlled to use the virtual prop in the usage manners corresponding to the at least two interaction regions. For example, the virtual prop may be used in the usage manner corresponding to a random one of the at least two interaction regions. For another example, the virtual prop may be used in the usage manner corresponding to a selected one of the at least two interaction regions, which is not limited in this disclosure.

In an aspect of this disclosure, since the displayed picking control includes the at least two interaction regions, the virtual object may be controlled to use the virtual prop in the usage manners corresponding to the at least two interaction regions, and a player does not need to select a virtual prop first and then select a usage manner of the virtual prop, thereby reducing operations of a plurality of usage manners such as virtual prop picking and replacement, and improving virtual prop usage efficiency. Correspondingly, control operations (for controlling virtual prop picking or replacement) performed by a player in a network game are reduced. In this case, services provided by a server of the network game based on the control operations performed by the player are reduced, thereby reducing resource consumption required by the server, and reducing operating pressure of the server.

FIG. 4 is a flowchart of a method for using a virtual prop (i.e., a method for controlling a virtual object) according to an aspect of this disclosure. The method includes the following operation 402, operation 404, and operation 406. The method shown in FIG. 4 is an exemplary implementation of the above method. For example, operation 1 of the above method may be achieved through operation 404, and operation 2 of the above method may be achieved through operation 406.

Operation 402: Control the virtual object to move in a three-dimensional virtual environment in response to a control operation performed on the virtual object.

The three-dimensional virtual environment is a virtual environment displayed (or provided) when an application program runs in a terminal. The virtual environment may be a simulated world of the real world, a semi-simulated and semi-fabricated world, or a completely fabricated environment. The virtual object is a movable object in the three-dimensional virtual environment. The movable object may be a virtual character, a virtual animal, a cartoon character, or the like. The three-dimensional virtual environment is merely an example of a virtual environment, and a form of the virtual environment is not limited in this disclosure. For example, the virtual environment may be a two-dimensional virtual environment or a virtual environment of another form. Correspondingly, operation 402 may be controlling the virtual object to move in the virtual environment in response to the control operation performed on the virtual object, the virtual object being a movable object in the virtual environment.

For example, the control operation performed on the virtual object is an operation configured to control the virtual object to move. The operation may be a touch control operation performed on a touchscreen, or may be a control operation performed on the virtual object through an external device such as a game joystick or a mouse. For example, a player may click/tap a touchscreen of a mobile terminal to control the virtual object to move to a position corresponding to the clicking/tapping operation in the three-dimensional virtual environment. For another example, the player may operate directional keys on the game joystick to control the virtual object to move in the three-dimensional virtual environment.

Referring to FIG. 3, a virtual object 320 is displayed on a display interface 310. In response to a control operation performed on the virtual object 320, the virtual object 320 may move in the three-dimensional virtual environment displayed on the display interface 310.

Operation 404: Display a picking control in response to the virtual object entering a picking region in the three-dimensional virtual environment.

Based on the above content, in response to the control operation, the virtual object may be controlled to move in the three-dimensional virtual environment. After the virtual object enters the picking region, the picking control may be displayed, to facilitate use of at least one virtual prop in the picking region by the player. Since the virtual object is controlled to move in the virtual environment in operation 402, the virtual object may enter, based on the control operation, a region in the virtual environment at which the virtual object is allowed to arrive. The region at which the virtual object is allowed to arrive includes but is not limited to the picking region. The picking region may be configured for picking up the virtual prop. Therefore, operation 404 may be displaying the picking control in response to the virtual object entering the picking region in the three-dimensional virtual environment through movement.

For example, the method provided in an aspect of this disclosure further includes obtaining first position information of the virtual object, the first position information being configured for indicating a position of the virtual object; obtaining second position information of the picking region, the second position information being configured for indicating a position of the picking region; and determining, based on the first position information and second position information, whether the virtual object enters the picking region in the virtual environment through the movement. For example, if it is determined based on the first position information and second position information that the position of the virtual object is within a position of the picking region, it is determined that the virtual object enters the picking region in the virtual environment through the movement.

For example, the position of the virtual object is a point, the position of the picking region is a region, and the region in which the picking region is located includes region edges and a region interior defined by the region edges. If the point at which the virtual object is located is on the edge of the region or falls within the region, it may be determined that the virtual object enters the picking region of the virtual environment through the movement. Alternatively, the position of the virtual object and the position of the picking region are both regions. If the two regions completely or partially overlap, it may be determined that the virtual object enters the picking region of the virtual environment through the movement. Alternatively, the position of the virtual object is a region, the position of the picking region is a point (for example, the position of the picking region is a point, or the position of the picking region may be represented as a point (for example, the position of the picking region is a region, but the region is represented by a point on an edge of the region or a point inside the region)), and the region in which the virtual object is located includes region edges and a region interior defined by the region edges. If the point at which the picking region is located is on the edge of the region or falls within the region, it may be determined that the virtual object enters the picking region of the virtual environment through the movement.

For example, the virtual environment is considered as a coordinate system. The first position information is coordinates (equivalent to the above point) in the coordinate system, and the second position information is a coordinate set. The coordinate set includes coordinates (equivalent to the above region) in a plurality of coordinate systems. For example, the first position information is coordinates (5, 5), the picking region is a rectangular region, and the second position information includes coordinates (0, 0), (10, 0), (0, 10), and (10, 10) of four vertices of the picking region. It may be determined based on the first position information and the second position information that the point at which the virtual object is located falls within the picking region. Therefore, it may be determined that the virtual object enters the picking region in the virtual environment through the movement.

The picking region, for example, a virtual stall may be always displayed on the display interface. The picking region may be hidden on the display interface, and displayed after the virtual object enters the picking region. In another example, after the virtual object enters the picking region, the picking region may not be displayed, and only the at least one virtual prop included in the picking region is displayed. A dashed-line box shown in FIG. 3 represents the picking region. The picking region may include virtual props of different types. For example, the picking region includes a virtual prop 01 and a virtual prop 02 of different types. The virtual prop 01 and the virtual prop 02 each have a plurality of styles.

For example, the picking region includes at least one virtual prop. The picking control is a control corresponding to a to-be-used virtual prop (which is also referred to as a reference virtual prop) of the at least one virtual prop. In other words, the picking control corresponds to the reference virtual prop of the at least one virtual prop. The reference virtual prop may be all or some virtual props of the at least one virtual prop, and a quantity of reference virtual props is less than or equal to a quantity of the at least one virtual prop. When the at least one virtual prop includes one virtual prop, one reference virtual prop is provided. When the at least one virtual prop includes a plurality of (i.e., at least two) virtual props, one or more reference virtual props are provided. For example, that the picking control corresponds to the reference virtual prop of the at least one virtual prop may be that each picking control corresponds to at least one reference virtual prop. For example, the picking controls are in a one-to-one correspondence with the reference virtual props.

In an aspect of this disclosure, in response to the virtual object entering the picking region in the virtual environment through the movement, the at least one virtual prop included in the picking region is determined, the reference virtual prop is determined from the at least one virtual prop, and the picking control corresponding to the reference virtual prop is displayed. For example, a specified quantity of virtual props of the at least one virtual prop may be determined as the reference virtual prop. Alternatively, a virtual prop of the at least one virtual prop at a specified position may be determined as the reference virtual prop (for example, referring to FIG. 3, the at least one virtual prop is displayed in two rows, and the specified position may be in a first row or a second row). Alternatively, a virtual prop of the at least one virtual prop satisfying a screening condition may be determined as the reference virtual prop. Satisfying the screening condition may mean having a specified type, a specified style, or the like, which is not limited herein. The screening condition may be a configured default condition, or may be a condition set by the player, which is also not limited herein.

At least two interaction regions are displayed in the picking control. The at least two interaction regions displayed in the picking control respectively correspond to at least one usage manner of the to-be-used virtual prop. In other words, each of the at least two interaction regions corresponds to at least one usage manner of the to-be-used virtual prop. Since the at least two interaction regions are displayed in the picking control, the player may subsequently (for example, in operation 406) trigger any interaction region. For example, the player performs a triggering operation on any one of the at least two interaction regions, to use the to-be-used virtual prop in the usage manner corresponding to the interaction region. Referring to FIG. 3, an example in which the to-be-used virtual prop is a virtual prop 1 is used. A first interaction region 331 and a second interaction region 332 are displayed in a picking control 330.

As described above, each picking control corresponds to at least one reference virtual prop.

If each picking control corresponds to only one reference virtual prop, and each interaction region corresponds to only one usage manner, after subsequently triggering an interaction region in a picking control, the player may use a reference virtual prop corresponding to the picking control based on a usage manner corresponding to the interaction region.

If each picking control corresponds to a plurality of reference virtual props, and each interaction region corresponds to only one usage manner, after subsequently triggering an interaction region in a picking control, the player may respectively use a plurality of reference virtual props corresponding to the picking control based on a usage manner corresponding to the interaction region.

If each picking control corresponds to one reference virtual prop, and each interaction region corresponds to a plurality of usage manners, after subsequently triggering an interaction region in a picking control, the player may use a reference virtual prop corresponding to the picking control a plurality of times based on a plurality of usage manners corresponding to the interaction region.

If each picking control corresponds to a plurality of reference virtual props, and each interaction region corresponds to a plurality of usage manners, after subsequently triggering an interaction region in a picking control, the player may use each of the plurality of reference virtual props corresponding to the picking control a plurality of times based on a plurality of usage manners corresponding to the interaction region (for example, a reference virtual prop 1 is used separately based on a usage manner 1 and a usage manner 2, and a reference virtual prop 2 is used separately based on the usage manner 1 and the usage manner 2). Alternatively, for each of the plurality reference virtual props corresponding to the picking control, the reference virtual prop is used in a usage manner selected from the plurality of usage manners corresponding to the interaction region (an interaction region triggered by the player) (for example, the reference virtual prop 1 is used based on the usage manner 1, and the reference virtual prop 2 is used based on the usage manner 2; or for another example, the reference virtual prop 1 is used based on the usage manner 2, and the reference virtual prop 2 is used based on the usage manner 1).

Another interaction region may be further displayed in the picking control corresponding to the to-be-used virtual prop. In the following, an example in which two interaction regions are displayed in the picking control is used. A relevant description of displaying three or more interaction regions is similar to that of displaying two interaction regions. Details are not described.

Based on the above content, in a case that the picking region includes a plurality of virtual props, the plurality of virtual props may be virtual props of different types. For example, the plurality of virtual props included in the picking region may be any one of a virtual fighting prop, a virtual accessory, and a virtual decorative prop. In an aspect, a display style of the picking control is determined based on a type of the to-be-used virtual prop.

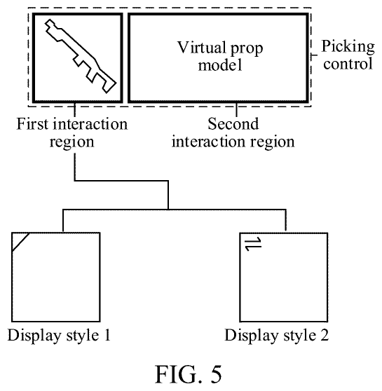

An example in which a first interaction region and a second interaction region are displayed in the picking control is used. FIG. 5 is a schematic diagram of a picking control according to an aspect of this disclosure. In addition, a pattern style of the to-be-used virtual prop is displayed in the first interaction region, and a model of the to-be-used virtual prop is displayed in the second interaction region.

To-be-used virtual props of different types may be distinguished from each other through different display styles. Referring to FIG. 5, the first interaction region is used as an example. A to-be-used virtual prop of a first type adopts a display style 1, and a to-be-used virtual prop of a second type adopts a display style 2. The display style 1 and the display style 2 are different display styles. In an aspect, the display style of the picking control may include at least one type of the following display information:
frame colors of the at least two interaction regions;
corner marks of the at least two interaction regions;
brightness of the at least two interaction regions;
shapes of the at least two interaction regions;
transparencies of the at least two interaction regions;
pattern styles in the at least two interaction regions; and
text styles in the at least two interaction regions.

Any one of the display information such as the frame color, the corner mark, the brightness, the shape, the transparency, the pattern style, and the text style of each interaction region may be set based on an actual need, which is not limited in this aspect of this disclosure.

Referring to FIG. 5, it is assumed that the first type is a virtual fighting prop, and the second type is a virtual accessory of the virtual fighting prop. For a first interaction region corresponding to the virtual fighting prop, the display style 1 may be used. For a first interaction region corresponding to the virtual accessory, the display style 2 may be used.

The display style 1 and the display style 2 may be distinguished from each other through frame colors, corner marks, and pattern styles. For example, in the display style 1, the frame color is blue, the corner mark is a triangle, and the pattern style is a pattern of the virtual fighting prop. In the display style 2, the frame color is orange, the corner mark is a double sided arrow, and the pattern style is a pattern of the virtual accessory.

Display styles of different interaction regions of the same to-be-used virtual prop may be different. For example, if the to-be-used virtual prop is a virtual fighting prop, a first interaction region of the virtual fighting prop may adopt the display style 1. In a display style of a second interaction region of the virtual fighting prop, a frame color is blue, no corner mark is displayed, and a name of the virtual fighting prop is displayed in the second interaction region. The name may further carry associated information of the virtual fighting prop, for example, a model of the virtual fighting prop and associated virtual props.

In an aspect of this disclosure, the picking region may include a plurality of virtual props. Referring to FIG. 3, the picking region includes a virtual prop 01 and a virtual prop 02 of different types, and the virtual prop 01 and the virtual prop 02 each have a plurality of styles.

In an aspect of this disclosure, the picking region includes a first candidate virtual prop and a second candidate virtual prop is used. After the virtual object 320 enters the picking region, a first picking control and a second picking control may be displayed. The first picking control is a control corresponding to the first candidate virtual prop, the second picking control is a control corresponding to the second candidate virtual prop, and a display style of the first picking control is different from a display style of the second picking control.

Referring to FIG. 3, an example in which the first candidate virtual prop is the virtual prop 1 and the second candidate virtual prop is the virtual prop 2 is used. After the player controls the virtual object 320 to enter the picking region, the picking control 330 corresponding to the virtual prop 1 and the picking control 340 corresponding to the virtual prop 2 are displayed on the display interface 310.

Display styles of the picking control 330 and the picking control 340 are different. The two picking controls may be distinguished from each other through a plurality of types of display information such as a frame color, a corner mark, a brightness, a shape, a transparency, a pattern style, and a text style displayed in at least two interaction regions of the two picking controls.

Operation 406: Use, in response to a triggering operation performed on a triggered interaction region of at least two interaction regions, a to-be-used virtual prop in a usage manner corresponding to the triggered interaction region.

The triggered interaction region may also be referred to as a target interaction region (or a reference interaction region), which is an interaction region determined to be triggered after being selected by the player. As described above, the picking control includes the at least two interaction regions. The player may browse the at least two interaction regions, and determine, based on an own intention, an interaction region that needs to be selected. Next, the player may perform a triggering operation on the interaction region that needs to be selected, so that the interaction region at which the triggering operation is targeted becomes a triggered interaction region, i.e., a reference interaction region. An interaction region on which the player performs the triggering operation is the interaction region at which the triggering operation is targeted. Therefore, operation 406 may be controlling, in response to the triggering operation performed on a reference interaction region of the at least two interaction regions, the virtual object to use the reference virtual prop in the usage manner corresponding to the reference interaction region at which the triggering operation is targeted. The reference interaction region is all or some of the at least two interaction regions displayed in the picking control. One or more reference interaction regions may be provided. Certainly, a quantity of the reference interaction regions is less than or equal to a quantity of the displayed at least two interaction regions.

In an aspect, usage manners of the to-be-used virtual prop include at least one of replacement, equipment, dressing, storage, giving, and exchange into virtual currency. For example, if the player triggers the triggered interaction region, a first virtual prop used by the virtual object is replaced with the to-be-used virtual prop. For another example, if the player triggers the triggered interaction region, a second virtual prop stored in a virtual backpack of the virtual object is updated to a combined virtual prop. The combined virtual prop is composed of the second virtual prop and the to-be-used virtual prop. For another example, if the player triggers the triggered interaction region, the to-be-used virtual prop is exchanged into virtual currency, and a stock of virtual currency of the virtual object is increased.

In an aspect, based on different usage manners of the to-be-used virtual prop, the usage manner corresponding to each of the at least two interaction regions includes at least one of the following usage manners:
replacing a first virtual prop used by the virtual object with the to-be-used virtual prop, the first virtual prop being a virtual prop of the same type as the to-be-used virtual prop;
replacing a second virtual prop reserved by the virtual object with the to-be-used virtual prop, the second virtual prop being a virtual prop of the same type as the to-be-used virtual prop;
replacing a third virtual prop used by the virtual object with the to-be-used virtual prop, the third virtual prop being a virtual prop that is of the same type as, but of a different style from, the to-be-used virtual prop;
replacing a fourth virtual prop reserved by the virtual object with the to-be-used virtual prop, the fourth virtual prop being a virtual prop that is of the same type as, but of a different style from, the to-be-used virtual prop;
upgrading a fifth virtual prop owned by the virtual object to the to-be-used virtual prop, the fifth virtual prop being a virtual prop of the same type as the to-be-used virtual prop;
updating a sixth virtual prop owned by the virtual object to a combined virtual prop, the combined virtual prop being generated through combination of the sixth virtual prop and the to-be-used virtual prop;
putting the to-be-used virtual prop into the virtual backpack;
giving the to-be-used virtual prop to another virtual object;
equipping the virtual object with the to-be-used virtual prop or dressing the virtual object in the to-be-used virtual prop; and
exchanging the to-be-used virtual prop into virtual currency.

The usage manners corresponding to the at least two interaction regions may be set based on an actual need.

The virtual prop owned by the virtual object includes at least one of a virtual prop currently used by the virtual object, a reserved virtual prop, and a virtual prop put into the virtual backpack.

An example in which the to-be-used virtual prop is a virtual fighting prop is used. If the fifth virtual prop is a virtual fighting prop of the same type as the virtual prop currently used by the virtual object, the fifth virtual prop in the virtual backpack may be upgraded. To be specific, the fifth virtual prop is updated to the to-be-used virtual prop. In an aspect, the fifth virtual prop may be directly discarded, or may be put into the virtual backpack.

An example in which the to-be-used virtual prop is a virtual top is used. If the sixth virtual prop is a virtual skirt put by the virtual object into the virtual backpack, the virtual top and the virtual skirt may be combined to obtain a virtual suit. In an aspect, the virtual suit may be put into the virtual backpack, or may directly replace a virtual suit currently worn by the virtual object.

An example in which the to-be-used virtual prop is a virtual accessory is used. In response to the triggering operation performed on the triggered interaction region, the virtual accessory may be given to a friend virtual object, or the virtual accessory may be given to a specified virtual object, or the virtual accessory may be exchanged into virtual currency and stored.

Referring to FIG. 3, the to-be-used virtual prop is the virtual prop 1 is used. In the picking control 330 corresponding to the virtual prop 1, the usage manner corresponding to the first interaction region 331 may be replacing the second virtual prop reserved by the virtual object with the to-be-used virtual prop, and the usage manner corresponding to the second interaction region 332 may be replacing the first virtual prop used by the virtual object with the to-be-used virtual prop.

Similarly, the example in which the to-be-used virtual prop is the virtual prop 2 is used. In the picking control 340 corresponding to the virtual prop 2, the usage manner corresponding to the first interaction region 341 may be replacing the first virtual prop used by the virtual object with the to-be-used virtual prop, and the usage manner corresponding to the second interaction region 342 may be putting the to-be-used virtual prop into the virtual backpack.

In summary, for example, after the virtual object enters the picking region in the three-dimensional virtual environment, the at least two interaction regions are displayed in the picking control, so that the player can use the to-be-used virtual prop in the usage manners corresponding to the different interaction regions through the triggering operations performed on the different interaction regions, thereby reducing operations of a plurality of usage manners such as virtual prop picking and replacement, and improving virtual prop usage efficiency. Correspondingly, control operations (for controlling virtual prop picking or replacement) performed by a player in a network game are reduced. In this case, services provided by a server of the network game based on the control operations performed by the player are reduced, thereby reducing resource consumption required by the server, and reducing operating pressure of the server.

Based on the above content, the to-be-used virtual prop may correspond to a plurality of usage manners. In an aspect, each of the at least two interaction regions displayed in the picking control corresponds to at least one usage manner of the to-be-used virtual prop, and different interaction regions correspond to different usage manners.

In an aspect, one interaction region corresponds to one usage manner of the to-be-used virtual prop. In another example, one interaction region corresponds to at least two usage manners of the to-be-used virtual prop, and the at least two usage manners corresponding to each interaction region are different.

In an aspect, operation 406 may be implemented by: using, in response to a triggering operation performed on the first interaction region of the at least two interaction regions, the to-be-used virtual prop in a first usage manner corresponding to the first interaction region; and using, in response to a triggering operation performed on a second interaction region of the at least two interaction regions, the to-be-used virtual prop in a second usage manner corresponding to the second interaction region. The first usage manner includes one or more usage manners, and the second usage manner includes one or more usage manners. A quantity of the usage manners included in the first usage manner is the same or different from a quantity of the usage manners included in the second usage manner. In addition, the first usage manner is different from the second usage manner. For example, when any one of the usage manners included in the first usage manner is different from any one of the usage manners included in the second usage manner, it is considered that the first usage manner is different from the second usage manner. For another example, when the usage manners included in the first usage manner are not completely consistent with the usage manners included in the second usage manner, it is considered that the first usage manner is different from the second usage manner.

In an aspect, usage manners of the to-be-used virtual prop include at least one of replacement, equipment, dressing, storage, giving, and exchange into virtual currency. In an aspect, specific manners of the first usage manner and the second usage manner may be set based on an actual need. For relevant descriptions of the usage manners, reference may be made to the above content, and details are not described.

Based on the above content, the to-be-used virtual prop has a plurality types. For example, the to-be-used virtual prop may be one of a virtual fighting prop, a virtual accessory, and a virtual decorative prop. Based on the different types of the to-be-used virtual prop, in response to a triggering operation performed on the triggered interaction region, the to-be-used virtual prop may be used in different usage manners.

The implementations of operation 406 are provided below based on the types of the to-be-used virtual prop:

1. The to-be-used virtual prop (i.e., the reference virtual prop) is a virtual fighting prop, and the triggered interaction region (i.e., the reference interaction region at which the triggering operation is targeted) is at least one of the first interaction region and the second interaction region.

In an aspect, operation 406 may be implemented by: controlling the virtual object to replace the first virtual prop used by the virtual object with the to-be-used virtual prop (which is a virtual fighting prop in this implementation), or equipping the virtual object with the to-be-used virtual prop (or controlling the virtual object to be equipped with the virtual prop) in response to the triggering operation performed on the first interaction region of the at least two interaction regions, the first virtual prop being a virtual fighting prop of the same type as the to-be-used virtual prop; and controlling the virtual object to replace the second virtual prop reserved by the virtual object with the to-be-used virtual prop or controlling the virtual object to put the to-be-used virtual prop into the virtual backpack in response to a triggering operation performed on the second interaction region of the at least two interaction regions, the second virtual prop being a virtual fighting prop of the same type as the to-be-used virtual prop.

The usage manners respectively corresponding to the first interaction region and the second interaction region may be replaced.

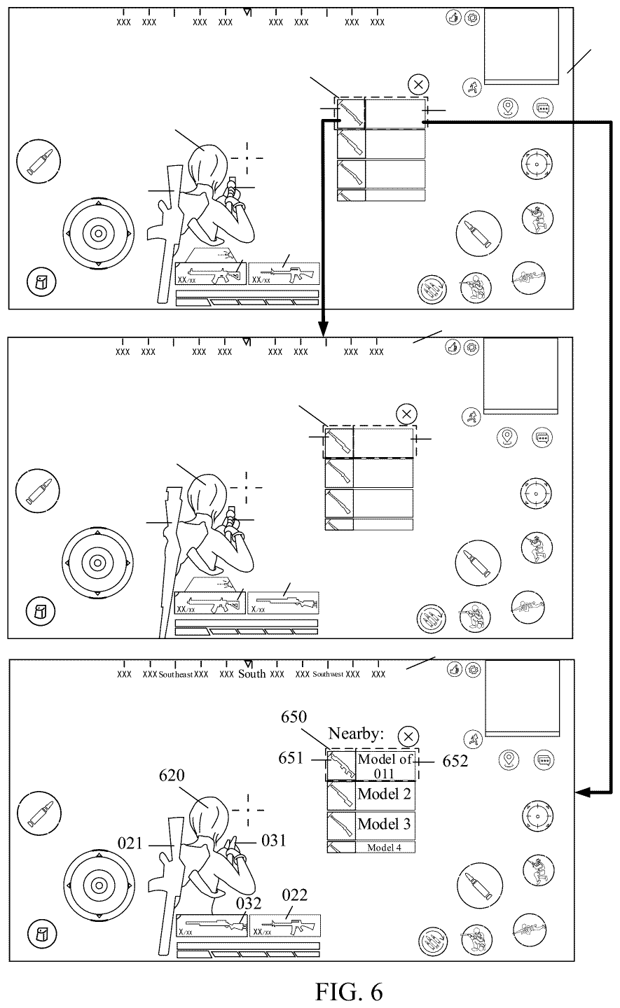

An example in which the usage manner corresponding to the first interaction region is replacing the second virtual prop reserved by the virtual object with the to-be-used virtual prop and the usage manner corresponding to the second interaction region is replacing the first virtual prop used by the virtual object with the to-be-used virtual prop is used. FIG. 6 is a schematic interface diagram of a method for using a virtual prop according to an aspect of this disclosure.

A virtual object 620 is displayed on a display interface 610. In response to a control operation performed on the virtual object 620, the virtual object 620 may be controlled to move in a three-dimensional virtual environment displayed on the display interface 610. After the virtual object 620 enters a picking region (not shown in the figure), a plurality of picking controls are displayed.

An example in which a to-be-used virtual prop is a virtual prop of a model 1 is used. After the virtual object 620 enters the picking region, a picking control 630 of the virtual prop of the model 1 is displayed. A first interaction region 631 and a second interaction region 632 are displayed in the picking control 630.

In an aspect, a virtual fighting prop owned by the virtual object 620 is further displayed on the display interface 610. The virtual object 620 holds a first virtual prop 011 with a hand. The first virtual prop 011 is a virtual fighting prop currently being used by the virtual object 620. In addition, the virtual object 620 wears a second virtual prop 021 on a shoulder. The second virtual prop 021 is a virtual fighting prop reserved by the virtual object 620. A player may replace the second virtual prop 021 with the virtual fighting prop currently being used through a replacement operation. In this case, the first virtual prop 011 is changed to the reserved virtual fighting prop.

In an aspect, prop display regions of the first virtual prop 011 and the second virtual prop 021 are further displayed on the display interface 610. The prop display region of the first virtual prop 011 is 012, and the prop display region of the second virtual prop 021 is 022.

Referring to FIG. 6, an example in which the first virtual prop 011 is a virtual shooting prop is used. Virtual shooting props of a plurality of models are displayed on the display interface 610. Assuming that the to-be-used virtual prop is the virtual shooting prop of the model 1, the first virtual prop 011, the second virtual prop 021, and the virtual shooting prop of the model 1 are virtual fighting props of the same type.

An example in which the first interaction region 631 and the second interaction region 632 are displayed in the picking control 630 is used.

(1) In an aspect, if the player triggers the first interaction region 631, the second virtual prop 021 reserved by the virtual object 620 is replaced with the virtual shooting prop of the model 1.

Referring to FIG. 6, after the first interaction region 631 is triggered, the picking control 630 of the virtual shooting prop of the model 1 is no longer displayed on the display interface 610, and a picking control 640 of a virtual shooting prop of a model 2 is displayed by updating at a display position of the picking control 630. A first interaction region 641 and a second interaction region 642 are displayed in the picking control 640.

In addition, on the display interface 610, the second virtual prop 021 worn on the shoulder of the virtual object 620 is replaced with a third virtual prop 031 for display. The third virtual prop 031 is the virtual shooting prop of the model 1. In addition, the prop display region 022 of the second virtual prop 021 is updated to a prop display region 032 of the third virtual prop 031.

(2) In an aspect, if the player triggers the second interaction region 632, the first virtual prop 011 used by the virtual object 620 is replaced with the virtual shooting prop of the model 1.

Referring to FIG. 6, after the first interaction region 631 is triggered, the picking control 630 of the virtual shooting prop of the model 1 is no longer displayed on the display interface 610, and a picking control 650 of the first virtual prop 011 is displayed by updating at the display position of the picking control 630. A first interaction region 651 and a second interaction region 652 are displayed in the picking control 650.

In addition, on the display interface 610, the first virtual prop 011 held by the virtual object 620 with the hand is replaced with the third virtual prop 031 for display. The third virtual prop 031 is the virtual shooting prop of the model 1. In addition, the prop display region 012 of the first virtual prop 011 is updated to the prop display region 032 of the third virtual prop 031.

In an aspect, after the first virtual prop 011 is replaced with the virtual shooting prop of the model 1 for use, the first virtual prop 011 may be directly discarded, or the first virtual prop 011 may put into the virtual backpack for subsequent use. After the second virtual prop 021 is replaced with the virtual shooting prop of the model 1, the second virtual prop 021 may be directly discarded, or the second virtual prop 021 may be put into the virtual backpack.

2. The to-be-used virtual prop (i.e., the reference virtual prop) is a virtual accessory of the virtual fighting prop, and the triggered interaction region (i.e., the reference interaction region at which the triggering operation is targeted) is at least one of the first interaction region and the second interaction region.

In an aspect, operation 406 may be implemented by: controlling the virtual object to update the third virtual prop used by the virtual object to the to-be-used virtual prop (which is the virtual accessory of the virtual fighting prop in this implementation) in response to the triggering operation performed on the first interaction region of the at least two interaction regions, the third virtual prop being a virtual accessory that is of the same type as, but of a different style from, the to-be-used virtual prop; and controlling the virtual object to replace the fourth virtual prop reserved by the virtual object with the to-be-used virtual prop, controlling the virtual object to update the fifth virtual prop owned by the virtual object to the to-be-used virtual prop, or controlling the virtual object to put the to-be-used virtual prop into the virtual backpack in response to the triggering operation performed on the second interaction region of the at least two interaction regions, the fourth virtual prop being a virtual accessory that is of the same type as, but of a different style from, the to-be-used virtual prop, and the fifth virtual prop being a virtual accessory of the same type as the to-be-used virtual prop.

The usage manners respectively corresponding to the first interaction region and the second interaction region may be replaced, and the above example is merely exemplary.

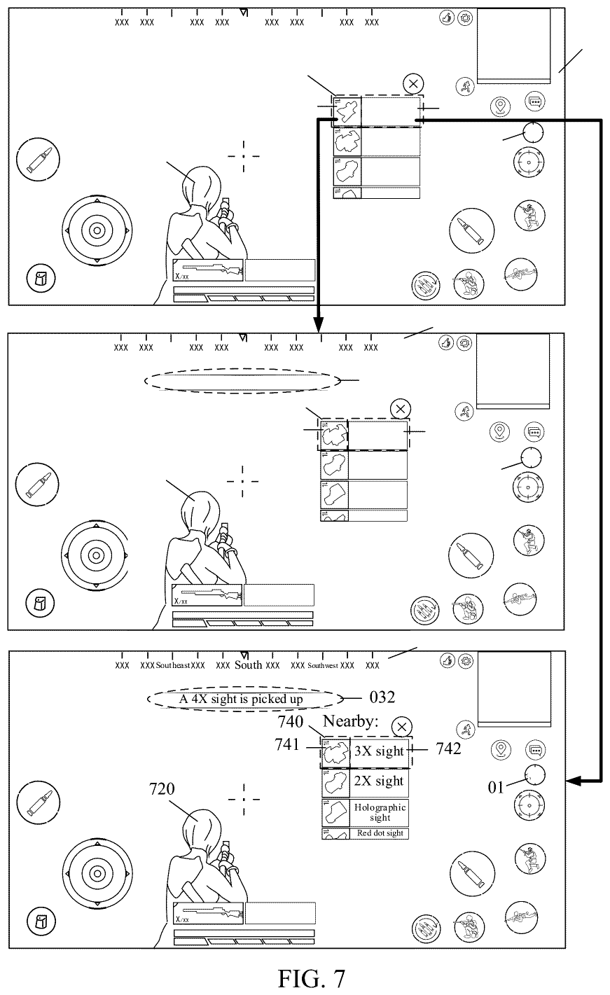

An example in which the usage manner corresponding to the first interaction region is updating the third virtual prop used by the virtual object to the to-be-used virtual prop and the usage manner corresponding to the second interaction region is putting the to-be-used virtual prop into the virtual backpack is used. FIG. 7 is a schematic interface diagram of a method for using a virtual prop according to an aspect of this disclosure.

A virtual object 720 is displayed on a display interface 710. In response to a control operation performed on the virtual object 720, the virtual object 720 may be controlled to move in a three-dimensional virtual environment displayed on the display interface 710. After the virtual object 720 enters a picking region (not shown in the figure), a plurality of picking controls are displayed.

An example in which the virtual accessory is a virtual sight of the virtual fighting prop is used. When the virtual object 720 enters the picking region, the virtual object 720 is equipped with a 2× sight. In an aspect, a prop display region 01 of a virtual accessory with which the virtual object is currently equipped is further displayed on the display interface 710. The 2× sight is displayed in the prop display region 01.

It is assumed that the to-be-used virtual prop is a 4× sight. After the virtual object 720 enters the picking region, a picking control 730 of the 4× sight is displayed. A first interaction region 731 and a second interaction region 732 are displayed in the picking control 730.

Referring to FIG. 7, an example in which the virtual accessory is a virtual sight of the virtual fighting prop is used. Virtual sights of a plurality of styles are displayed on the display interface 710. Assuming that the to-be-used virtual prop is the 4× sight, the 2× sight with which the virtual object 720 is equipped is a virtual accessory that is of the same type as, but of a different style from, the 4× sight.

The example in which the first interaction region 731 and the second interaction region 732 are displayed in the picking control 730 is still used.

(1) In an aspect, if the player triggers the first interaction region 731, the 2× sight used by the virtual object 720 is replaced with the 4× sight.

Referring to FIG. 7, after the first interaction region 731 is triggered, the picking control 730 of the 4× sight is no longer displayed on the display interface 710, and a picking control 740 of a 3× virtual sight is displayed by updating at a display position of the picking control 730. A first interaction region 741 and a second interaction region 742 are displayed in the picking control 740.

In addition, the prop display region 01 of the 2× sight is updated to a prop display region 02 of the 4× sight on the display interface 710. In an aspect, a prompt control 031 is further displayed on the display interface 710, which is configured to indicate that the replacement of the virtual accessory is completed.

In an aspect, after the 2× sight is replaced with the 4× sight for use, the 2× sight may be directly discarded, or the 2× sight may be put into the virtual backpack for subsequent use.

(2) In an aspect, if the player triggers the second interaction region 732, 4× sight is put into the virtual backpack.

Referring to FIG. 7, after the first interaction region 731 is triggered, the picking control 730 of the 4× sight is no longer displayed on the display interface 710, and a picking control 740 of a 3× virtual sight is displayed by updating at a display position of the picking control 730. A first interaction region 741 and a second interaction region 742 are displayed in the picking control 740.

In an aspect, a prompt control 032 is further displayed on the display interface 710, which is configured to indicate that pickup of the virtual accessory is completed.

3. The to-be-used virtual prop (i.e., the reference virtual prop) is a virtual decorative prop, and the triggered interaction region (i.e., the reference interaction region at which the triggering operation is targeted) is at least one of the first interaction region and the second interaction region.

In an aspect, operation 406 may be implemented by: controlling the virtual object to replace the first virtual prop used by the virtual object with the to-be-used virtual prop (which is a virtual decorative prop in this implementation), or dress the virtual object in the to-be-used virtual prop (or controlling the virtual object to be dressed in the virtual decorative prop) in response to the triggering operation performed on the first interaction region of the at least two interaction regions, the first virtual prop being a virtual decorative prop of the same type as the to-be-used virtual prop; and controlling the virtual object to put the to-be-used virtual prop into the virtual backpack, controlling the virtual object to give the to-be-used virtual prop to another virtual object, or controlling the virtual object to exchange the to-be-used virtual prop into virtual currency in response to the triggering operation performed on the second interaction region of the at least two interaction regions.

The usage manners respectively corresponding to the first interaction region and the second interaction region may be replaced, and the above example is merely exemplary.

An example in which the usage manner corresponding to the first interaction region is replacing the first virtual prop used by the virtual object with the to-be-used virtual prop and the usage manner corresponding to the second interaction region is giving the to-be-used virtual prop to another virtual object or exchanging the to-be-used virtual prop into the virtual currency is used. An example in which the to-be-used virtual prop is a virtual helmet is used. If the player triggers the first interaction region, the virtual object may be dressed in the virtual helmet. If the player triggers the second interaction region, the virtual helmet may be given to a specified virtual object, or the virtual helmet may be exchange into the virtual currency, and a stock of virtual currency of the virtual object is increased.

A difference exists between contents displayed on the display interface when different interaction regions are triggered. For the difference, reference may be made to the relevant descriptions of the above two manners, and details are not described.

The above three implementations all involve the process of controlling the virtual object to use the reference virtual prop in a specific usage manner. The control process may be visualized, or may be non-visualized, which is not limited in the aspect of this disclosure. An example in which the virtual object is controlled to put the reference virtual prop into the virtual backpack is used. If the control process is visualized, the process of putting the reference virtual prop into the virtual backpack by the virtual object may be displayed (for example, the virtual object picks up the reference virtual prop, opens the backpack, and then puts the reference virtual prop into the virtual backpack), and the reference virtual prop is correspondingly added to the virtual backpack. If the control process is non-visualized, the process of putting the reference virtual prop into the virtual backpack by the virtual object may be not displayed, and the reference virtual prop is added to the virtual backpack.

In summary, for example, in the method for using a virtual prop provided in the aspects of this disclosure, a plurality of implementations of using the to-be-used virtual prop are provided based on the different types of the virtual props.

For example, combinations of a plurality of other usage manners corresponding to the at least two interaction regions all fall within the protection scope of this disclosure. Details are not described.

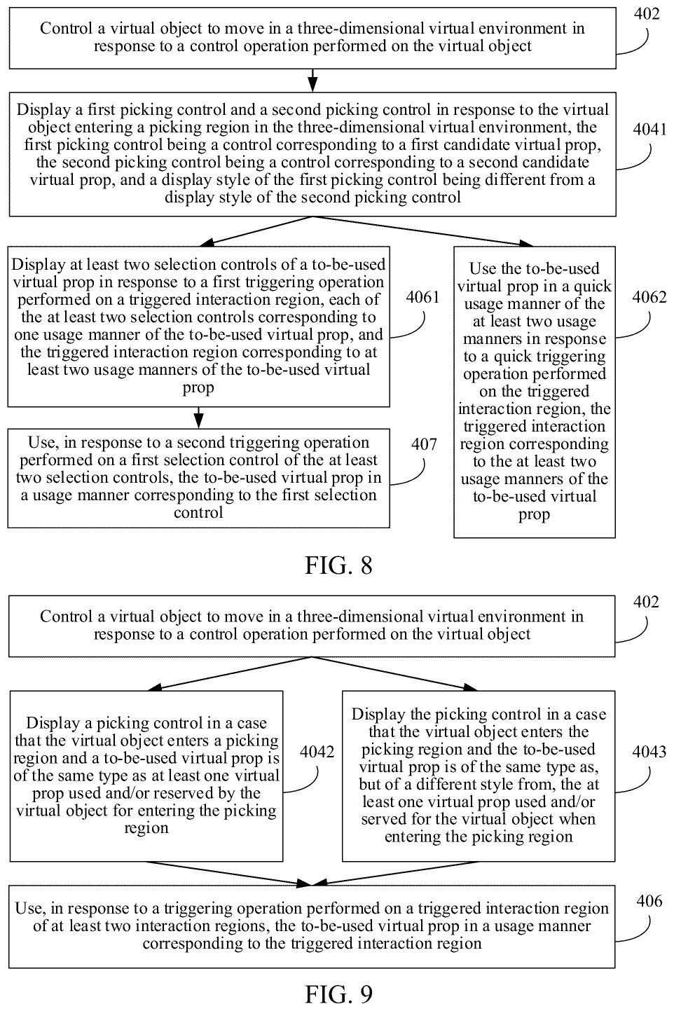

Based on FIG. 4, FIG. 8 is a flowchart of a method for using a virtual prop (i.e., a method for controlling a virtual object) according to an aspect of this disclosure. Operation 404 may be implemented as operation 4041, and operation 406 may be implemented as operation 4061 or operation 4062. One of operation 4061 and operation 4062 is performed, rather than both of them are performed.

In an example, the picking region includes a plurality of virtual props. In this case, picking controls corresponding to the plurality of virtual props may be displayed. In an aspect, display styles of the picking controls are determined based on types of the to-be-used virtual props (i.e., reference virtual props). Referring to FIG. 5, the first interaction region is used as an example. A to-be-used virtual prop of a first type adopts a display style 1, a to-be-used virtual prop of a second type adopts a display style 2, and the display style 1 and the display style 2 are different display styles.

In an aspect, the picking region includes a first candidate virtual prop and a second candidate virtual prop. In other words, the at least one virtual prop included in the picking region includes the first candidate virtual prop and the second candidate virtual prop, and the to-be-used virtual prop is the first candidate virtual prop or the second candidate virtual prop. In this case, operation 404 may be implemented as operation 4041. Details are as follows:

Operation 4041: Display a first picking control and a second picking control in response to the virtual object entering a picking region in the three-dimensional virtual environment. For example, the first picking control and the second picking control are displayed in response to the virtual object entering the picking region in the virtual environment through the movement.

In an aspect, the first picking control is a control corresponding to the first candidate virtual prop, the second picking control is a control corresponding to the second candidate virtual prop, and a display style of the first picking control is different from a display style of the second picking control.

Based on the above content, in response to the control operation, the virtual object may be controlled to move in the three-dimensional virtual environment. After the virtual object enters the picking region, the picking control may be displayed, to facilitate use of at least one virtual prop in the picking region by the player.

In a case that the picking region includes the first candidate virtual prop and the second candidate virtual prop, the first picking control and the second picking control are displayed. At least two interaction regions displayed in each of the first picking control and the second picking control respectively correspond to a plurality of usage manners of the first candidate virtual prop and the second candidate virtual prop. The player may determine the to-be-used virtual prop from the first candidate virtual prop and the second candidate virtual prop by triggering any interaction region, and use the to-be-used virtual prop in a usage manner corresponding to the interaction region (i.e., control the virtual object to use the to-be-used virtual prop in the usage manner corresponding to the interaction region).

Based on the above content, in a case that the picking region includes a plurality of virtual props, the plurality of virtual props may be virtual props of different types. For example, the plurality of virtual props included in the picking region may be any one of a virtual fighting prop, a virtual accessory, and a virtual decorative prop.

To distinguish between the first picking control and the second picking control, display styles of the first picking control and the second picking control may be set to different styles. The display style may be set based on an actual need, or may be customized by the player.

In an aspect, the display style of the picking control may include at least one type of the following display information: frame colors of the at least two interaction regions; corner marks of the at least two interaction regions; brightness of the at least two interaction regions; shapes of the at least two interaction regions; transparencies of the at least two interaction regions; pattern styles in the at least two interaction regions; and text styles in the at least two interaction regions.

It is assumed that the first candidate virtual prop is a virtual fighting prop and the second candidate virtual prop is a virtual accessory of the virtual fighting prop. The display style of the first picking control corresponding to the first candidate virtual prop and the display style of the second picking control corresponding to the second candidate virtual prop may be displayed in the following manners:

In an aspect, the display styles of the first picking control and the second picking control may be distinguished from each other through frame colors, corner marks, and pattern styles. An example in which the picking region includes two interaction regions is used. The display style of the first picking control may be as follows: Frame colors of the two interaction regions are blue, a corner mark of the first interaction region is a triangle, and no corner mark exists in the second interaction region. The first interaction region displays a pattern of the virtual fighting prop, and the second interaction region displays a name of the virtual fighting prop. The display style of the second picking control may be as follows: Frame colors of the two interaction regions are orange, a corner mark of the first interaction region is a double sided arrow, and no corner mark exists in the second interaction region. The first interaction region displays a pattern of the virtual accessory, and the second interaction region displays a model of the virtual accessory.

Based on the above content, each of the at least two interaction regions displayed in the picking control corresponds to at least one usage manner of the to-be-used virtual prop, and different interaction regions correspond to different usage manners. In an example, the triggered interaction region corresponds to the at least two usage manners of the to-be-used virtual prop. The at least two usage manners corresponding to the triggered interaction region are all different from a plurality of usage manners of a non-triggered interaction region.

For example, referring to FIG. 7, an example in which the to-be-used virtual prop is the 4× sight and the triggered interaction region is the first interaction region 731 is used. The usage manner corresponding to the first interaction region 731 is replacing the 2× sight used by the virtual object 720 with the 4× sight, or equipping the virtual object 720 with the 4× sight. In this case, in response to a triggering operation performed on the first interaction region 331, at least one of the at least two usage manners to be used needs to be determined. Assuming that the non-triggered interaction region is the second interaction region 732, a usage manner corresponding to the second interaction region 732 may be putting the 4× sight into the virtual backpack, or exchanging the 4× sight into virtual currency.

In an aspect, in a case that the triggered interaction region corresponds to at least two usage manners of the to-be-used virtual prop, operation 406 may be implemented as operation 4061 or operation 4062. Details are as follows:

Operation 4061: Display at least two selection controls of the to-be-used virtual prop (i.e., a reference virtual prop) in response to a first triggering operation performed on the triggered interaction region.

In an aspect, each of the at least two selection controls corresponds to one usage manner of the to-be-used virtual prop, and the triggered interaction region corresponds to at least two usage manners of the to-be-used virtual prop.

Operation 407: Use, in response to a second triggering operation performed on a first selection control of the at least two selection controls, the to-be-used virtual prop in a usage manner corresponding to the first selection control (for example, controlling the virtual object to use the to-be-used virtual prop in the usage manner corresponding to the first selection control).

The at least two selection controls are configured to select the manner of using the to-be-used virtual prop by the player.

Referring to FIG. 7, an example in which the to-be-used virtual prop is the 4× sight and the triggered interaction region is the first interaction region is used. In response to the first triggering operation performed on the first interaction region 731, at least two selection controls (not shown in the figure) of the 4× sight are displayed. Each of the at least two selection controls corresponds to one usage manner of the 4× sight. In response to the second triggering operation performed on the first selection control of the at least two selection controls, the 4× sight is used in the usage manner corresponding to the first selection control.

For example, referring to FIG. 7, when the player clicks/taps the first interaction region 731, a pull-down menu is displayed on a left side of the first interaction region 731. The pull-down menu displays a plurality of usage manners of the 4× sight. Each usage manner corresponds to a selection control. Subsequently, the player selects a to-be-used usage manner, and clicks/taps a selection control corresponding to the usage manner, to achieve the use of the 4× sight.

Operation 4062: Use the to-be-used virtual prop in a quick usage manner of the at least two usage manners (for example, controlling the virtual object to use the to-be-used virtual prop in the quick usage manner of the at least two usage manners) in response to a quick triggering operation performed on the triggered interaction region, the triggered interaction region corresponding to the at least two usage manners of the to-be-used virtual prop.

The quick triggering operation and the quick usage manner both may be set based on an actual need, or may be customized by the player.

Referring to FIG. 7, the example in which the to-be-used virtual prop is the 4× sight and the triggered interaction region is the first interaction region is still used. In response to a quick triggering operation performed on the first interaction region 731, the 4× sight is used in the quick usage manner of the at least two usage manners. For example, the player may double click/tap the first interaction region 731, and then use the 4× sight in a usage manner customized by the player.

The above two example implementations may be implemented in combination.

Referring to FIG. 7, the example in which the to-be-used virtual prop is the 4× sight and the triggered interaction region is the first interaction region 731 is still used. If the player clicks/taps the first interaction region 731, the pull-down menu is displayed on the left side of the first interaction region 731. If the player double clicks/taps the first interaction region 731, the 4× sight is used in the usage manner customized by the player.

In summary, in the method for using a virtual prop (i.e., the method for controlling a virtual object) provided in an aspect of this disclosure, the differences between the display styles of the pickup control are provided, the types of the display styles of the picking control are provided. Based on the above, through the different display styles, the type of the virtual prop and/or the different usage manners corresponding to the virtual prop can be quickly determined.

In an aspect, in a case that the triggered interaction region corresponds to the at least two usage manners of the to-be-used virtual prop, an aspect of this disclosure further provides implementation solutions of two selection usage manners. Different usage manners are used in response to different triggering operations, which further improves the virtual prop usage efficiency.

In an aspect, to improve usage efficiency of the to-be-used virtual prop, the picking control may be displayed in a case that a display condition is satisfied. For example, in a case that a candidate virtual prop that is of the same type as the virtual prop currently used by the virtual object exists in the picking region, a picking control corresponding to the candidate virtual prop is displayed.

Based on FIG. 4, FIG. 9 is a flowchart of a method for using a virtual prop (i.e., a method for controlling a virtual object) according to an aspect of this disclosure. In this case, operation 404 may be implemented as operation 4042 or operation 4043. Details are as follows:

Operation 4042: Display a picking control in a case that the virtual object enters a picking region and a to-be-used virtual prop is of the same type as at least one virtual prop used and/or reserved by the virtual object for entering the picking region, or display the picking control when the virtual object enters the picking region through movement and a reference virtual prop is of the same type as the at least one virtual prop used and/or reserved by the virtual object for entering the picking region.

Operation 4043: Display the picking control in a case that the virtual object enters the picking region and the to-be-used virtual prop is of the same type as, but of a different style from, the at least one virtual prop used and/or reserved by the virtual object for entering the picking region, i.e., display the picking control when the virtual object enters the picking region through movement and a reference virtual prop is of the same type as, but of a different style from, the at least one virtual prop used and/or reserved by the virtual object for entering the picking region.

One of operation 4042 and operation 4043 is performed, rather than both of them are performed.

A virtual shooting game is used as an example. When the virtual object enters the picking region, the virtual object holds a virtual shooting prop with a hand, a virtual sight is mounted to the virtual shooting prop, and the virtual object does not wear a virtual helmet. In this case, in response to the virtual object entering the picking region, picking controls corresponding to a plurality of virtual props are displayed on the display interface for selection by the player.

In an aspect, in a case that the virtual object enters the picking region and the to-be-used virtual prop is of the same type as the virtual shooting prop, the picking control of the to-be-used virtual prop is displayed.

In another aspect, in a case that the virtual object enters the picking region and the to-be-used virtual prop is of the same type as, but of a different style, from the virtual sight, the picking control of the to-be-used virtual prop is displayed.

After the virtual object enters the picking region, at least whether the candidate virtual prop in the picking region is of the same type as the at least one virtual prop currently used and/or reserved by the virtual object needs to be determined. The at least one virtual prop used and/or reserved by the virtual object for entering the picking region may be at least one virtual prop (a virtual prop of a first type) used by the virtual object for entering the picking region, or may be at least one virtual prop (a virtual prop of a second type) reserved by the virtual object for entering the picking region, or may be the virtual prop of the first type and the virtual prop of the second type. Subsequently, in a case that the candidate virtual prop in the picking region is of the same type as the at least one virtual prop currently used and/or reserved by the virtual object, the picking control of the candidate virtual prop is displayed.

Further, if the at least one virtual prop currently used and/or reserved by the virtual object further includes a plurality of styles of the same type, after it is determined whether the candidate virtual prop in the picking region is of the same type as the at least one virtual prop currently used and/or reserved by the virtual object, it further needs to be determined whether the candidate virtual prop in the picking region is of the same style as the at least one virtual prop currently used and/or reserved by the virtual object. Subsequently, in a case that the candidate virtual prop in the picking region is of a different style from the at least one virtual prop currently used and/or reserved by the virtual object, the picking control of the candidate virtual prop is displayed.

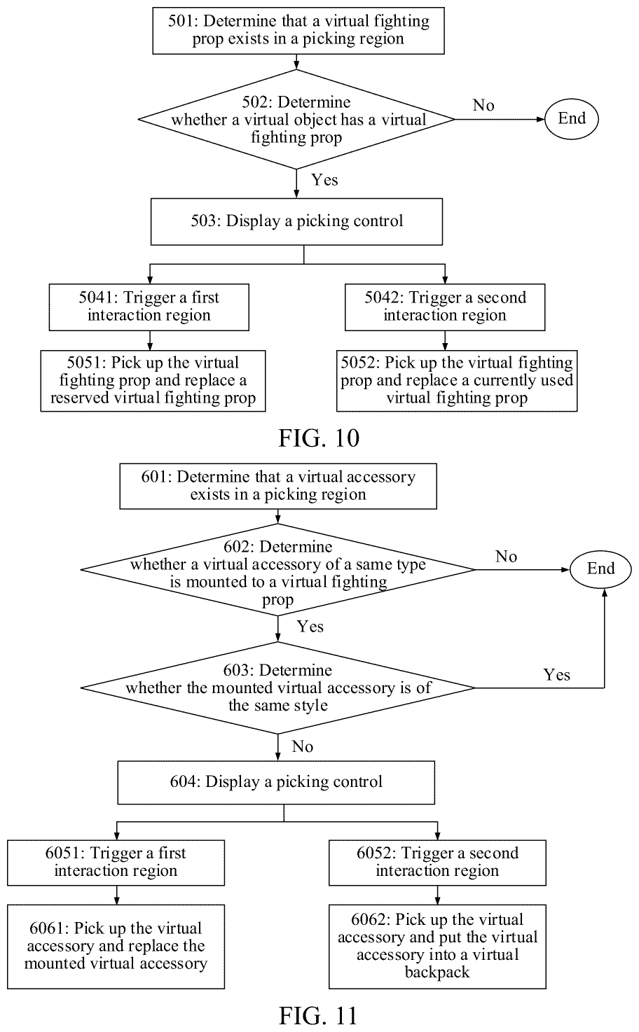

An example in which the to-be-used virtual prop is a virtual fighting prop is used. FIG. 10 is a flowchart of a method for using a virtual prop (i.e., a method for controlling a virtual object) according to an aspect of this disclosure. The method includes the following operations:

Operation 501: Determine that a virtual fighting prop exists in a picking region.

Operation 502: Determine whether a virtual object has a virtual fighting prop.

That a virtual object has a virtual fighting prop may be understood as that the virtual object currently uses at least one virtual fighting prop and/or the virtual object has at least one reserved virtual fighting prop.

Operation 503: Display a picking control in a case the virtual object enters a picking region, the virtual object has the virtual fighting prop, and the two virtual fighting props are of a same type.

The virtual fighting prop in the picking region may be understood as a to-be-used virtual prop.

In an aspect, if the virtual object does not have the virtual fighting prop, a single interaction region is displayed. In response to a triggering operation performed on the interaction region, the virtual fighting prop in the picking region is put into a virtual backpack.

In an aspect, a first interaction region and a second interaction region are displayed in the picking control.

An example in which the virtual object currently uses one virtual fighting prop and the virtual object has one reserved virtual fighting prop is used. Operation 5041 and operation 5051 may be performed, or operation 5042 and operation 5052 may be performed.

Operation 5041: Trigger a first interaction region.

Operation 5051: Pick up the virtual fighting prop and replace a reserved virtual fighting prop.

For example, the virtual object wears a virtual shooting prop on a shoulder. When a player triggers the first interaction region, the virtual shooting prop worn on the shoulder of the virtual object is replaced with a virtual shooting prop in the picking region.

Operation 5042: Trigger a second interaction region.

Operation 5052: Pick up the virtual fighting prop and replace a currently used virtual fighting prop.

For example, the virtual object currently uses a virtual shooting prop. When the player triggers the second interaction region, the virtual shooting prop currently used by the virtual object is replaced with the virtual shooting prop in the picking region.

One of operation 5041 and operation 5042 is performed, rather than both of them are performed.

An example in which the to-be-used virtual prop is a virtual accessory of the virtual fighting prop is still used. FIG. 11 is a flowchart of a method for using a virtual prop (i.e., a method for controlling a virtual object) according to an aspect of this disclosure. The method includes the following operations:

Operation 601: Determine that a virtual accessory exists in a picking region.

Operation 602: Determine whether a virtual accessory of a same type is mounted to a virtual fighting prop.

That the virtual accessory of the same type is mounted to the virtual fighting prop may be understood as that the virtual accessory mounted to the virtual fighting prop is a virtual accessory of the same type as the virtual accessory in the picking region.

Operation 603: Determine whether the mounted virtual accessory is of the same style.

That the mounted virtual accessory is of the same style may be understood as that the virtual accessory mounted to the virtual fighting prop is a virtual accessory of the same type and style as the virtual accessory in the picking region.

Operation 604: Display a picking control in a case that a virtual object enters the picking region and the mounted virtual accessory is of a different style from the virtual accessory in the picking region.

The virtual accessory in the picking region may be understood as a to-be-used virtual prop.

In an aspect, if the mounted virtual accessory is of the same style as the virtual accessory in the picking region, a single interaction region is displayed. In response to a triggering operation performed on the interaction region, the virtual accessory in the picking region is put into a virtual backpack.

In an aspect, a first interaction region and a second interaction region are displayed in the picking control.

An example in which a virtual fighting prop currently used by the virtual object has a virtual accessory that is of the same type as, but of a different style from, the virtual accessory in the picking region mounted thereon is used. Operation 6051 and operation 6061 may be performed, or operation 6052 and operation 6062 may be performed.

Operation 6051: Trigger a first interaction region.

Operation 6061: Pick up the virtual accessory and replace the mounted virtual accessory.

For example, when a player triggers the first interaction region, the virtual accessory mounted to the virtual fighting prop currently used by the virtual object is replaced with the virtual accessory in the picking region.

Operation 6052: Trigger a second interaction region.

Operation 6062: Pick up the virtual accessory and put the virtual accessory into a virtual backpack.

For example, when the player clicks/taps the second interaction region, the virtual accessory in the picking region is put into the virtual backpack.

One of operation 6051 and operation 6052 is performed, rather than both of them are performed.

In summary, in the method for using a virtual prop provided in an aspect of this disclosure, the display conditions of displaying the picking control are provided, which avoids display of a picking control of a candidate virtual prop unrelated to the virtual prop used or reserved by the virtual object on the display interface, thereby further improving virtual prop usage efficiency.

Subdivision of virtual props varies based on different network games and changing actual needs.

The “same type” mentioned above is based on a general division of the virtual props, and the “same style” mentioned above is based on a bottom-layer division of the virtual props. Another subdivision manner may exist between the “same type” and the “same style”. If the another subdivision manner exists between the same type and the same style, determination for the another subdivision manner may be added in the method for using a virtual prop provided in this disclosure. Details are not described.

In an aspect, the to-be-used virtual prop (i.e., the reference virtual prop) may correspond to n usage manners, and m interaction regions are displayed in the picking control, n being a positive integer greater than zero, and m being a positive integer less than n. For example, the to-be-used virtual prop corresponds to 5 usage manners, but only 2 interaction regions may be displayed in the picking control. In this case, if one interaction region corresponds to one usage manner, to-be-displayed interaction regions corresponding to two usage manners need to be determined.

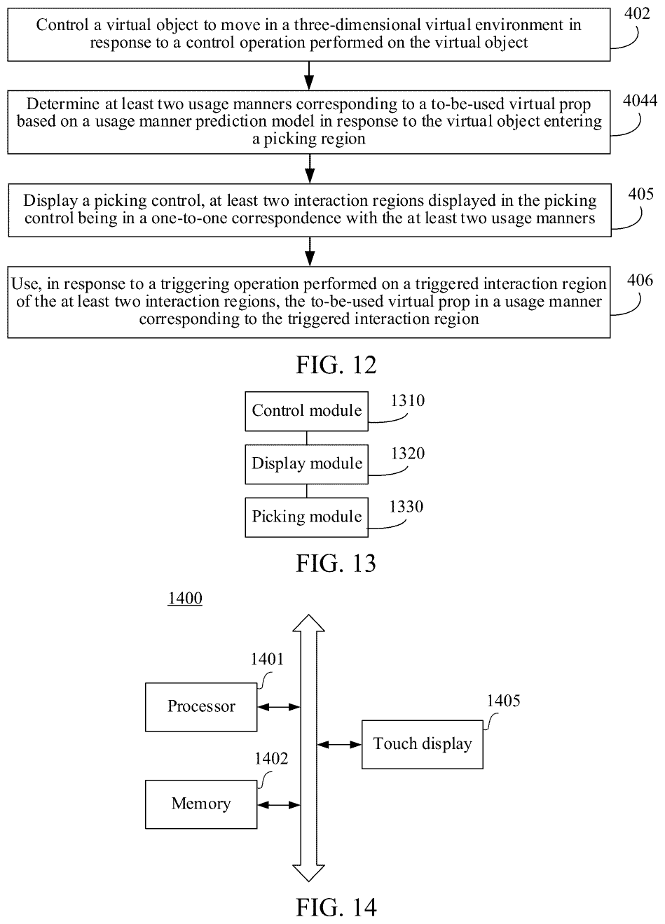

Based on FIG. 4, FIG. 12 is a flowchart of a method for using a virtual prop (i.e., a method for controlling a virtual object) according to an aspect of this disclosure. In this case, operation 404 may be implemented as operation 4044 and operation 405. Details are as follows:

Operation 4044: Determine at least two usage manners corresponding to a to-be-used virtual prop based on a usage manner prediction model in response to the virtual object entering a picking region.

Operation 405: Display a picking control, at least two interaction regions displayed in the picking control being in a one-to-one correspondence with the at least two usage manners.

An example in which two interaction regions are displayed in the picking control is used. The player controls the virtual object to enter the picking region, and obtains all virtual props in the picking region and virtual props owned by the virtual object. Subsequently, the above plurality of virtual props are inputted into the usage manner prediction model, and two usage manners of at least one to-be-used virtual prop are determined through the model. After the two usage manners are determined, at least one picking control corresponding to the at least one to-be-used virtual prop is displayed on the display interface. Two interaction regions are displayed in each picking control. Each interaction region corresponds to a usage manner determined through the above model.

In an aspect, the usage manner prediction model is trained based one at least one type of the following information:
historical usage data of at least one virtual prop included in the picking region;
historical usage data about use of at least one virtual prop by the virtual object in a current round of virtual battle;
historical usage data about use of at least one virtual prop by the virtual object in at least one round of historical virtual battle;
historical usage data about use of at least one virtual prop by another virtual object having the same or similar attribute as the virtual object in the current round of virtual battle;
historical usage data about use of at least one virtual prop by the another virtual object in at least one round of historical virtual battle;
historical usage data corresponding to a first control account configured for controlling the virtual object;
associated information of the first control account;
historical usage data corresponding to a second control account configured for controlling the another virtual object; and
associated information of the second control account.

The historical usage data of the at least one virtual prop is configured for indicating record data about use of the at least one virtual prop by at least one player in a game, including but not limited to at least one type of the following record data: replacement record data, equipment record data, dressing record data, storage record data, giving record data, and exchange record data. The above plurality of types of record data is configured for recording a specific usage manner of a corresponding virtual prop. For a description of the usage manner of the virtual prop, reference may be made to the above content, and details are not described.

The attribute of the virtual object may be set based on an actual need. For example, the another virtual object and the virtual object are both female virtual objects. For another example, the another virtual object and the virtual object have the same or similar functions in a virtual battle.

The historical usage data corresponding to the control account is configured for indicating all usage data of all virtual props corresponding to the account. The associated information of the control account includes a gender, an age, a usage preference, and the like of the account.

In an aspect, the training of the usage manner prediction model may be performed base on an actual need.

For example, for the virtual prop 1, historical usage data of the virtual prop 1 and the historical usage data corresponding to the first control account configured for controlling the virtual object are used as information in a training set, to obtain the usage manner prediction model through training. The model trained in this manner can select a most frequently used usage manner of the plurality of usage manners of the virtual prop 1, and the usage manner may be a usage manner most frequently used by the first control account.

For another example, for the virtual prop 1, historical usage data of the virtual prop 1 and an age of the first control account configured for controlling the virtual object are used as the information in the training set, to obtain the usage manner prediction model through training. The model trained in this manner can perform specific prediction for an age group, so as to select a usage manner of the virtual prop 1 most frequently used by players of the age group.

Based on the above examples, the usage manner prediction model trained based on different information can select different usage manners from the plurality of usage manners corresponding to the to-be-used virtual prop.

In an aspect, the to-be-used virtual prop corresponds to n usage manners. In this case, operation 4044 may be implemented by:
determining at least two usage manners with a highest selection probability from the n usage manners based on the usage manner prediction model in response to the virtual object entering the picking region; or
determining at least two usage manners with a highest usage frequency from the n usage manners based on the usage manner prediction model in response to the virtual object entering the picking region; or
determining at least two usage manners with a highest usage benefit from the n usage manners based on the usage manner prediction model in response to the virtual object entering the picking region; or
determining at least two usage manners with a highest matching degree with the virtual object from the n usage manners based on the usage manner prediction model in response to the virtual object entering the picking region; or
determining at least two usage manners with a highest matching degree with a team in which the virtual object is located from the n usage manners based on the usage manner prediction model in response to the virtual object entering the picking region; or
determining at least two usage manners with the highest matching degree with an associated object of the virtual object from n usage manners based on the usage manner prediction model in response to the virtual object entering the picking region; or
determining at least two usage manners with a highest matching degree with another virtual prop used by the virtual object from the n usage manners based on the usage manner prediction model in response to the virtual object entering the picking region.

The at least two usage manners with the highest selection probability are usage manners enabling the virtual object to have a highest winning probability in a current round of battle. The at least two usage manners with the highest usage frequency are usage manners most likely to be selected and used by the virtual object in the current round of battle. The at least two usage manners with the highest usage benefit are usage manners enabling the virtual object to maximize an effect in the current round of battle. The effect may be one of improving a fighting capability of the virtual object, assisting the virtual object, assisting the associated object of the virtual object, assisting the team in which the virtual object is located, and striking a fighting object or team of the virtual object. The highest matching degree is similar to the highest usage benefit. The at least two usage manners with the highest matching degree can provide a largest usage benefit for the virtual object in the current round of battle.

In an aspect, the above plurality of implementations are performed based on a fighting scenario of the virtual object in the current round of battle.

For example, after the virtual object enters the picking region, based on a virtual fighting prop with which the virtual object is equipped in a current fighting scenario and a fighting virtual object in the current round of battle, the at least two usage manners with the highest selection probability are determined from the n usage manners of the to-be-used virtual prop based on the usage manner prediction model. The at least two usage manners with the highest selection probability improve a probability that the virtual object wins in the current round of battle.

In an aspect, based on the fact that the usage manners are predicted by using the usage manner prediction model, a display style of an i^{th} interaction region of the at least two interaction regions may be distinguished from other interaction regions based on an i^{th} usage manner of the at least two usage manners. Each of the at least two usage manners corresponds to a display style different from each other, and i is a positive integer greater than 0.

The display style corresponding to each interaction region may be set based on an actual need.

In an aspect, the at least two interaction regions may be distinguished from each other based on at least one type of the following display information: a frame color of each interaction region; a corner mark of each interaction region; a brightness of each interaction region; a shape of each interaction region; a transparency of each interaction region; a pattern style of each interaction region; and a text style of each interaction region.

For example, the to-be-used virtual prop has 5 usage manners. The 5 usage manners correspond to 5 corner marks. When two interaction regions corresponding to two usage manners of the to-be-used virtual prop to be displayed are obtained through the usage manner prediction model, each of different corner marks in the two interaction regions corresponds to the usage manner corresponding to the interaction region.

In summary, in the method for using a virtual prop (i.e., the method for controlling a virtual object) provided in this disclosure, the prediction solution based on the usage manner prediction model is provided for a case that a quantity of usage manners of the to-be-used virtual prop and a quantity of interaction regions are inconsistent, so as to display an interaction region corresponding to a usage manner with a higher frequency in the picking control, thereby improving the virtual prop usage efficiency.

An aspect of this disclosure is described below. Reference may be made to the corresponding examples in the above disclosure, and the details are not described herein.

An aspect of this disclosure provides an apparatus for controlling a virtual object. The apparatus includes:
a display module, configured to display a picking control, the picking control including at least two interaction regions, each interaction region corresponding to a usage manner of a virtual prop; and
a picking module, configured to control the virtual object to use the virtual prop in the usage manners corresponding to the at least two interaction regions.

FIG. 13 is a schematic diagram of an apparatus for using a virtual prop (i.e., an apparatus for controlling a virtual object) according to an aspect of this disclosure. The apparatus includes the following control module 1310, display module 1320, and picking module 1330. The display module 1320 may be the display module included in the above apparatus, and the picking module 1330 may be the picking module included in the above apparatus.

The control module 1310 is configured to control the virtual object to move in a three-dimensional virtual environment in response to a control operation performed on the virtual object.

The display module 1320 is configured to display a picking control in response to the virtual object entering a picking region in the three-dimensional virtual environment, the picking region including at least one virtual prop, the picking control being a control corresponding to a to-be-used virtual prop of the at least one virtual prop, and at least two interaction regions being displayed in the picking control.

The picking module 1330 is configured to use, in response to a triggering operation performed on a triggered interaction region of at least two interaction regions, a to-be-used virtual prop in a usage manner corresponding to the triggered interaction region.

For example, the control module 1310 is configured to control the virtual object to move in a virtual environment in response to a control operation performed on a virtual object.

The display module 1320 is configured to display a picking control in response to the virtual object entering a picking region in the virtual environment through movement, the picking region including at least one virtual prop, the picking control corresponding to a reference virtual prop of the at least one virtual prop, and at least two interaction regions being displayed in the picking control.

The picking module 1330 is configured to control, in response to a triggering operation performed on a reference interaction region of the at least two interaction regions, the virtual object to use the reference virtual prop in a usage manner corresponding to the reference interaction region at which the triggering operation is targeted.

In an aspect, each of the at least two interaction regions corresponds to at least one usage manner of the to-be-used virtual prop, and different interaction regions correspond to different usage manners. For example, each of the at least two interaction regions corresponds to at least one usage manner of the reference virtual prop, and different interaction regions correspond to different usage manners.

In an aspect, the to-be-used virtual prop (i.e., the reference virtual prop) is a virtual fighting prop, and the reference interaction region at which the triggering operation is targeted is at least one of a first interaction region and a second interaction region. The picking module 1330 is configured to: control the virtual object to replace a first virtual prop used by the virtual object with the to-be-used virtual prop (i.e., the virtual fighting prop) or equip the virtual object with the to-be-used virtual prop (for example, control the virtual object to be equipped with the virtual fighting prop) in response to a triggering operation performed on the first interaction region of the at least two interaction regions, the first virtual prop being a virtual fighting prop of the same type as the to-be-used virtual prop; and control the virtual object to replace a second virtual prop reserved by the virtual object with the to-be-used virtual prop or control the virtual object to put the to-be-used virtual prop into a virtual backpack in response to a triggering operation performed on the second interaction region of the at least two interaction regions, the second virtual prop being a virtual fighting prop of the same type as the to-be-used virtual prop.

In an aspect, the to-be-used virtual prop (i.e., the reference virtual prop) is a virtual accessory of the virtual fighting prop, and the reference interaction region at which the triggering operation is targeted is at least one of a first interaction region and a second interaction region. The picking module 1330 is configured to: control the virtual object to update a third virtual prop used by the virtual object to the to-be-used virtual prop (i.e., the virtual accessory of the virtual fighting prop) in response to a triggering operation performed on the first interaction region of the at least two interaction regions, the third virtual prop being a virtual accessory that is of the same type as, but of a different style from, the to-be-used virtual prop; and control the virtual object to replace a fourth virtual prop reserved by the virtual object with the to-be-used virtual prop, control the virtual object to update a fifth virtual prop owned by the virtual object to the to-be-used virtual prop, or control the virtual object to put the to-be-used virtual prop into the virtual backpack in response to a triggering operation performed on the second interaction region of the at least two interaction regions, the fourth virtual prop being a virtual accessory that is of the same type as, but of a different style from, the to-be-used virtual prop, and the fifth virtual prop being a virtual accessory of the same type as the to-be-used virtual prop.

In an aspect, the to-be-used virtual prop (i.e., the reference virtual prop) is a virtual decorative prop, and the reference interaction region at which the triggering operation is targeted is at least one of a first interaction region and a second interaction region. The picking module 1330 is configured to: control the virtual object to replace a first virtual prop used by the virtual object with the to-be-used virtual prop (i.e., the virtual decorative prop), or dress the virtual object in the to-be-used virtual prop (for example, control the virtual object to be dressed in the virtual decorative prop) in response to a triggering operation performed on the first interaction region of the at least two interaction regions, the first virtual prop being a virtual decorative prop of the same type as the to-be-used virtual prop; and control the virtual object to put the to-be-used virtual prop into a virtual backpack, control the virtual object to give the to-be-used virtual prop to another virtual object, or control the virtual object to exchange the to-be-used virtual prop into virtual currency in response to a triggering operation performed on the second interaction region of the at least two interaction regions.

In an aspect, the triggered interaction region corresponds to at least two usage manners of the to-be-used virtual prop. The picking module 1330 is configured to: display at least two selection controls of the to-be-used virtual prop in response to a first triggering operation performed on the triggered interaction region, each of the at least two selection controls corresponding to one usage manner of the to-be-used virtual prop; and use, in response to a second triggering operation performed on a first selection control of the at least two selection controls, the to-be-used virtual prop in the usage manner corresponding to the first selection control (for example, control the virtual object to use the reference virtual prop in the usage manner corresponding to the first selection control).

In an aspect, the triggered interaction region corresponds to at least two usage manners of the to-be-used virtual prop. The picking module 1330 is configured to use the to-be-used virtual prop in a quick usage manner of the at least two usage manners (for example, control the virtual object to use the reference virtual prop in the quick usage manner) in response to a quick triggering operation performed on the triggered interaction region.

In an aspect, a display style of the picking control is determined based on a type of the to-be-used virtual prop. In other words, the display style of the picking control is determined based on a type of the reference virtual prop.

In an aspect, the display style of the picking control includes at least one type of the following display information: frame colors of the at least two interaction regions; corner marks of the at least two interaction regions; brightness of the at least two interaction regions; shapes of the at least two interaction regions; transparencies of the at least two interaction regions; pattern styles in the at least two interaction regions; and text styles in the at least two interaction regions.

In an aspect, the picking region includes a first candidate virtual prop and a second candidate virtual prop. The to-be-used virtual prop is the first candidate virtual prop or the second candidate virtual prop. The display module 1320 is configured to display a first picking control and a second picking control in response to the virtual object entering the picking region. The first picking control is a control corresponding to the first candidate virtual prop, the second picking control is a control corresponding to the second candidate virtual prop, and a display style of the first picking control is different from a display style of the second picking control.

For example, the at least one virtual prop included in the picking region is a first candidate virtual prop and a second candidate virtual prop, and the reference virtual prop is the first candidate virtual prop or the second candidate virtual prop. The display module 1320 is configured to display a first picking control and a second picking control in response to the virtual object entering the picking region in the virtual environment through movement. The first picking control is a control corresponding to the first candidate virtual prop, the second picking control is a control corresponding to the second candidate virtual prop, and a display style of the first picking control is different from a display style of the second picking control.

In an aspect, the display module 1320 is configured to display a picking control in a case that the virtual object enters the picking region (for example, enters the picking region through movement) and the to-be-used virtual prop (i.e., the reference virtual prop) is of the same type as at least one virtual prop used and/or reserved by the virtual object for entering the picking region.

In an aspect, the display module 1320 is configured to display a picking control in a case that the virtual object enters the picking region (for example, enters the picking region through movement) and the to-be-used virtual prop (i.e., the reference virtual prop) is of the same type as, but of a different style from, at least one virtual prop used and/or reserved by the virtual object for entering the picking region.

In an aspect, the display module 1320 is configured to: determine at least two usage manners corresponding to the to-be-used virtual prop based on a usage manner prediction model in response to the virtual object entering the picking region; and display a picking control, at least two interaction regions displayed in the picking control being in a one-to-one correspondence with the at least two usage manners.

In an aspect, the usage manner prediction model is trained based one at least one type of the following information: historical usage data of at least one virtual prop included in the picking region; historical usage data about use of at least one virtual prop by the virtual object in a current round of virtual battle; historical usage data about use of at least one virtual prop by the virtual object in at least one round of historical virtual battle; historical usage data about use of at least one virtual prop by another virtual object having the same or similar attribute as the virtual object in the current round of virtual battle; historical usage data about use of at least one virtual prop by the another virtual object in at least one round of historical virtual battle; historical usage data corresponding to a first control account configured for controlling the virtual object; associated information of the first control account; historical usage data corresponding to a second control account configured for controlling the another virtual object; and associated information of the second control account.

In an aspect, a display style of an i^{th} interaction region of the at least two interaction regions is distinguished from other interaction regions based on an i^{th} usage manner of the at least two usage manners. Each of the at least two usage manners corresponds to a display style different from each other, i is a positive integer greater than 0.

FIG. 14 is a structural block diagram of a computer device 1400 according to an aspect of this disclosure. The computer device 1400 may be a portable mobile terminal, such as a smartphone, a tablet computer, or a player. The computer device 1400 may also be referred to as another name such as a user equipment or a portable terminal.

Generally, the computer device 1400 includes a processor 1401 and a memory 1402.

Processing circuitry, such as the processor 1401 may include one or more processing cores, for example, a 4-core processor and an 8-core processor. The processor 1401 may be implemented in at least one hardware form of a digital signal processor (DSP), a field-programmable gate array (FPGA), and a programmable logic array (PLA). The processor 1401 may alternatively include a main processor and a coprocessor. The main processor is configured to process data in an awake state, which is also referred to as a central processing unit (CPU). The coprocessor is a low power processor configured to process data in a standby state. In an aspect, the processor 1401 may have a graphics processing unit (GPU) integrated therein. The GPU is configured to render and draw content that needs to be displayed on a display. In an aspect, the processor 1401 may further include an artificial intelligence (AI) processor. The AI processor is configured to process computing operations related to machine learning.

The memory 1402 may include one or more computer-readable storage media, such as a non-transitory computer-readable storage medium. The memory 1402 may further include a high-speed random access memory and a non-volatile memory, for example, one or more disk storage devices or flash storage devices. In an aspect, the non-transitory computer-readable storage medium in the memory 1402 is configured to store at least one instruction, and the at least one instruction is configured to be executed by the processor 1401 to implement the method for using a virtual prop provided in an aspect of this disclosure.

In an aspect, the computer device 1400 may include a touch display 1405. The touch display 1405 is configured to display a UI. The UI may include graphics, texts, icons, videos, and any combination thereof. The touch display 1405 further has a capability of collecting a touch signal on or above a surface of the touch display 1405. The touch signal may be inputted into the processor 1401 as a control signal for processing. The touch display 1405 is configured to provide a virtual button and/or a virtual keyboard, which is also referred to as a soft button and/or a soft keyboard. In an aspect, one touch display 1405 may be arranged on a front panel of the computer device 1400. In an aspect, at least two touch displays 1405 may be respectively arranged on different surfaces of the computer device 1400 or may be folded. In an aspect, the touch display 1405 may be a flexible display, which is arranged on a bent surface or a folded surface of the computer device 1400. The touch display 1405 may alternatively arranged as a non-rectangular irregular pattern, i.e., a special-shaped screen. The touch display 1405 may be manufactured by using a liquid crystal display (LCD), an organic light-emitting diode (OLED), or the like.

A person skilled in the art may understand that the structure shown in FIG. 14 does not constitute a limitation on the computer device 1400, and the computer device may include more or fewer components than those shown in the figure, or some merged components, or different component arrangements.

The computer device includes a memory and a processor, the memory having at least one piece of program code stored therein, the program code being loaded and executed by the processor, to cause the computer device to implement the above method for using a virtual prop.

This disclosure further provides a non-transitory computer-readable medium, such as a non-volatile computer-readable storage medium. The non-volatile computer-readable storage medium having a computer program stored therein, the computer program being configured to be executed by a processor, to cause a computer device to implement the above method for using a virtual prop.

This disclosure further provides a chip, the chip including a programmable logic circuit and/or program instructions, an electronic device having the chip arranged therein, when running, being configured to implement the above method for using a virtual prop. The electronic device is, for example, a computer device.

This disclosure further provides a computer program product, the computer program product including computer instructions, the computer instructions being stored in a non-volatile computer-readable storage medium, a processor reading the computer instructions from the non-volatile computer-readable storage medium and executing the computer instructions, to cause a computer device to implement the above method for using a virtual prop.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. The character “/” generally indicates an “or” relationship between the associated objects.

A person of ordinary skill in the art may understand that all or some operations for implementing the above aspects may be completed through hardware, or may be completed by a program instructing relevant hardware. The program may be stored in a non-volatile computer-readable storage medium. The non-volatile computer-readable storage medium mentioned above may be a read-only memory, a disk, an optical disc, or the like.

The above descriptions are not intended to limit this disclosure. Any modification, equivalent replacement, or improvement made within the principle of this disclosure falls within the protection scope of this disclosure.

What is claimed is:

1. A method for controlling a virtual object, the method comprising:
displaying, by processing circuitry of a terminal device, a picking control that includes at least two interaction regions, one of the interaction regions corresponding to a usage manner of a virtual prop; and
controlling, in response to an operation performed on a reference interaction region of the at least two interaction regions, the virtual object to interact with a reference virtual prop in the reference interaction region of the at least two interaction regions.

2. The method according to claim 1, wherein the one of the interaction regions corresponds to the usage manner of the virtual prop, and different interaction regions correspond to different usage manners.

3. The method according to claim 1, wherein the displaying further comprises:
displaying the picking control when the virtual object enters a picking region in a virtual environment, the picking region including at least one virtual prop, the picking control corresponding to the reference virtual prop.

4. The method according to claim 1, wherein the controlling further comprises:
controlling the virtual object to replace a first virtual prop used by the virtual object with a virtual fighting prop or controlling the virtual object to be equipped with the virtual fighting prop in response to the operation performed on a first interaction region of the at least two interaction regions, the first virtual prop being a same type as the virtual fighting prop; and
controlling the virtual object to replace a second virtual prop reserved by the virtual object with the virtual fighting prop or controlling the virtual object to put the virtual fighting prop into a virtual backpack in response to the operation performed on the second interaction region of the two interaction regions, the second virtual prop being a same type as the virtual fighting prop.

5. The method according to claim 1, wherein the controlling further comprises:
controlling the virtual object to update a third virtual prop used by the virtual object to a virtual accessory of a virtual fighting prop in response to the operation performed on a first interaction region of the at least two interaction regions, the third virtual prop being a same type as the virtual accessory of the virtual fighting prop with a different display style;
controlling the virtual object to replace a fourth virtual prop reserved by the virtual object with the virtual accessory of the virtual fighting prop; and
controlling the virtual object to upgrade a fifth virtual prop of the virtual object to the virtual accessory of the virtual fighting prop, or controlling the virtual object to put the virtual accessory of the virtual fighting prop into a virtual backpack in response to the operation performed on a second interaction region of the at least two interaction regions,
the fourth virtual prop being the same type as the virtual accessory of the virtual fighting prop with a different display style, and the fifth virtual prop being a same type as the virtual accessory of the virtual fighting prop.

6. The method according to claim 3, wherein the reference virtual prop is a virtual decorative prop and the controlling further comprises:
controlling the virtual object to replace a first virtual prop used by the virtual object with the virtual decorative prop or controlling the virtual object to be dressed in the virtual decorative prop in response to the operation performed on a first interaction region of the at least two interaction regions, the first virtual prop being a same type as the virtual decorative prop; and
controlling the virtual object to put the virtual decorative prop into a virtual backpack, controlling the virtual object to give the virtual decorative prop to another virtual object, or controlling the virtual object to exchange the virtual decorative props into virtual currency in response to the operation performed on a second interaction region of the at least two interaction regions.

7. The method according to claim 3, wherein the picking region further comprises:
a first candidate virtual prop and a second candidate virtual prop, the reference virtual prop is one of the first candidate virtual prop or the second candidate virtual prop; and
displaying a first picking control and a second picking control in response to the virtual object entering the picking region in the virtual environment,
the first picking control being a control corresponding to the first candidate virtual prop, the second picking control being a control corresponding to the second candidate virtual prop, and a display style of the first picking control being different from the second picking control.

8. The method according to claim 3, further comprising:
displaying the picking control when the virtual object enters the picking region and the reference virtual prop is of a same type as the at least one virtual prop used and/or reserved by the virtual object for entering the picking region.

9. The method according to claim 3, further comprising:
displaying the picking control when the virtual object enters the picking region and the reference virtual prop is of a same type with a different display style as the at least one virtual prop used and/or reserved by the virtual object for entering the picking region.

10. The method according to claim 1, wherein
a display style of the picking control is determined based on a type of the virtual prop.

11. The method according to claim 10, wherein the display style of the picking control comprises:
frame colors of the at least two interaction regions;
marks of the at least two interaction regions;
brightness of the at least two interaction regions;
shapes of the at least two interaction regions;
transparencies of the at least two interaction regions;
pattern styles in the at least two interaction regions; or
text styles in the at least two interaction regions.

12. An apparatus for controlling a virtual object, comprising:
processing circuitry configured to:
display a picking control that includes at least two interaction regions, one of the interaction regions corresponding to a usage manner of a virtual prop; and
control, in response to an operation performed on a reference interaction region of the at least two interaction regions, the virtual object to interact with a reference virtual prop in the reference interaction region of the at least two interaction regions.

13. The apparatus according to claim 12, wherein the processing circuitry is further configured to:
display the picking control when the virtual object enters a picking region in a virtual environment, the picking region including at least one virtual prop, the picking control corresponding to the reference virtual prop.

14. The apparatus according to claim 13, wherein
the picking region includes a first candidate virtual prop and a second candidate virtual prop, the reference virtual prop is one of the first candidate virtual prop or the second candidate virtual prop, and the processing circuitry is further configured to:
display a first picking control and a second picking control in response to the virtual object entering the picking region in the virtual environment, and
the first picking control being a control corresponding to the first candidate virtual prop, the second picking control being a control corresponding to the second candidate virtual prop, and a display style of the first picking control being different from the second picking control.

15. The apparatus according to claim 13, wherein the processing circuitry further configured to:
display the picking control when the virtual object enters the picking region and the reference virtual prop is of a same type as the at least one virtual prop used and/or reserved by the virtual object for entering the picking region.

16. A non-transitory computer-readable storage medium, storing instructions which when executed by a processor cause the processor to perform:
displaying a picking control that includes at least two interaction regions, one of the interaction regions corresponding to a usage manner of a virtual prop; and
controlling, in response to an operation performed on a reference interaction region of the at least two interaction regions, a virtual object to interact with a reference virtual prop in the reference interaction region of the at least two interaction regions.

17. The non-transitory computer-readable storage medium according to claim 16, further comprises:
displaying the picking control when the virtual object enters a picking region in a virtual environment, the picking region including at least one virtual prop, the picking control corresponding to the reference virtual prop.

18. The non-transitory computer-readable storage medium according to claim 17, wherein
the picking region includes a first candidate virtual prop and a second candidate virtual prop, the reference virtual prop is one of the first candidate virtual prop or the second candidate virtual prop;
the instructions further cause the processor to perform displaying a first picking control and a second picking control in response to the virtual object entering the picking region in the virtual environment, and
the first picking control corresponds to the first candidate virtual prop, the second picking control corresponds to the second candidate virtual prop, and a display style of the first picking control is different from the second picking control.

19. The non-transitory computer-readable storage medium according to claim 17, wherein the instructions further cause the processor to perform:
displaying the picking control when the virtual object enters the picking region and the reference virtual prop is of a same type as the at least one virtual prop used and/or reserved by the virtual object for entering the picking region.
